(19) United States
(12) Patent Application Publication
(10) Pub. No.: US 2006/0209065 A1
(43) Pub. Date: Sep. 21, 2006

(54) Method and apparatus for occlusion culling of graphic objects

(75) Inventors: Eugene Lapidous, Saratoga, CA (US); Jianbo Zhang, Mountain View, CA (US); Guofang Jiao, San Jose, CA (US); Bozhan Chen, Sunnyvale, CA (US); Ji Zhou, Shanghai (CN)

Correspondence Address: Raymond Y. Chan, #128, 108 N. Ynez Ave., Monterey Park, CA, 91754, US

(73) Assignee: XGI Technology Inc. (Cayman)

(21) Appl. No.: 11/298,167

(22) Filed: Dec. 8, 2005

Related U.S. Application Data
(60) Provisional application No. 60/634,731, filed on Dec. 8, 2004.

(51) Int. Cl. G06T 15/40

(52) U.S. Cl. 345/422

(57) ABSTRACT

A method of occlusion culling of graphic objects, comprising the steps of storing a first mask and one or more depth values associated with areas inside and outside the mask for a pre-defined region, and evaluating the visibility of the primitive covering the same region, wherein visibility evaluation begins after the computation of the coverage mask of the primitive in the region, and the computation of one or more depth values representing the pixels of the primitive. The method of the present invention is a real-time method of generating per-region coverage mask and associated Z values after the second primitive is rendered in the same region, which can maximize the bandwidth savings for Z read for both overlapping and non-overlapping primitives, with different relations between their depth values.

### CROSS REFERENCE OF RELATED APPLICATION

This is a regular application of a provisional application, application No. 60/634,731, filed Dec. 08, 2004.

### BACKGROUND OF THE PRESENT INVENTION

1. Field of Invention

The present invention relates to computer graphics systems, and more particularly to computer graphics systems that render primitives utilizing at least one frame buffer and at least one depth buffer.

2. Description of Related Arts

Rendering three-dimensional (3D) scenes requires realistic representation of multiple objects in the field of view. Dependent on the distance of an object from the point of view, which is also known as camera position in 3D graphics, it may occlude or be occluded by other objects. Even when there is only one object, it is possible that some of its parts occlude or are occluded by others. As a result, methods and apparatus for resolving occlusions and eliminate hidden surfaces play important roles in the creation of realistic images of 3D scenes.

In order for a method of hidden surface elimination to work effectively, the depth resolution of an occluding object and the object being occluded must be greater than their minimal distance. Such method also has to be simple enough to be implemented in low-cost graphics hardware that accelerates 3D rendering, or with low-cost software renderer when hardware accelerators are not available.

Most algorithms for hidden surface elimination utilize depth buffer, also known as Z-buffer. As an example, a new pixel at two-dimensional location X, Y on the screen is associated with depth value Z. This depth value Z is compared with a depth value stored in a special buffer at the location corresponding to the same X, Y coordinate. A visibility test compares the new depth value Z to the stored depth value. If the new depth value Z phases the visibility test, the stored depth value in the depth buffer will be updated to the new depth value Z.

Bandwidth is required to access external buffers for storing color and depth values. It is a scarce resource which limits performance of modern 3D graphics accelerators. Bandwidth consumed by a depth buffer could be significantly larger than that consumed by a color buffer. For instance, if 50% of the pixels are rejected after visibility tests, the depth buffer may require 3 times more bandwidth than a color buffer because the depth values of all pixels are read and depth values of 50% of the pixels have to be written, while color values are only written for 50% of the pixels.

Prior art illustrated methods and systems are used to decrease depth buffer bandwidth without introducing image-rendering artifacts.

U.S. Pat. No. 5,844,571 describes Z buffer bandwidth reductions via split transactions, wherein least significant bits of the depth buffer are read only when visibility cannot be solved by reading the most significant bits. This method has a major drawback of decreasing only the Z read bandwidth, leaving the write bandwidth unaltered. The storage capacity of the buffer containing most significant bits is usually too large for practical on-chip storage. Performance may be degraded if large percentage of pixels is required for reading the least significant bits, thereby magnifying access latency.

More efficient reduction of the read bandwidth can be achieved through the use of the “hierarchical Z buffer”, additionally storing far or near Z values per block of pixels that cover predefined regions, and comparing those values with interpolated Z values for the new primitive.

For instance, if every interpolated Z value in an 8×8 region covered by the new primitive is smaller than the near Z value already stored in the same 8×8 region, the pixels in the new primitive are recognized as visible without having to read the exact Z values form the depth buffer. This solution, however, also only decreases the Z read bandwidth, but not the Z write bandwidth. It is less efficient especially when the surface of the object is made from a large number of small primitives.

As an example, two non-overlapping triangles are to be rendered one after another, where both triangles cover at least part of the same 8×8 region, wherein the first triangle has depth Z1 and the second triangle has Z2, where Z2≧Z1 and both triangles have to be rendered over the background with depth Z0, where Z0≧Z1 and Z0≧Z2.

Before the first triangle is rendered, the per-region storage contained a near Z value of Z0. Hence, the first triangle is resolved as visible without having to read the exact Z value as Z1 is smaller than Z0. After the first triangle is rendered, Z1 is stored as the near Z value for the region.

The second triangle does not overlap the first one, but since its Z2 value is inside the range [Z0, Z1] the exact Z values of the second triangle from the depth buffer must be read to resolve visibility. Therefore, Z read bandwidth is saved only while first primitive is rendered, but not while second primitive is rendered.

To solve the above problem, U.S. Pat. No. 6,646,639 describes a modified hierarchical Z buffer, wherein the per-region storage contains a coverage mask, having Z values inside and outside it.

Consider the same scenario of 2 non-overlapping triangles (depth Z1 and Z2), covering the same 8×8 region over background with depth Z0. Before the first triangle is being rendered, the per-region storage contained an outside mask near Z value of Z0 (out_Znear=Z0) and the coverage mask is empty. The first triangle is resolved as visible without having to read the exact Z values since all new pixels are outside the coverage mask, meaning that Z1 is less than out_Znear.

After the first triangle is rendered, the per-region coverage mask is replaced by the coverage mask of the first triangle for that region, wherein the inside mask near Z is represented by “in_Znear” and the outside mask near Z is represented by “out_Znear” wherein out_Znear=Z0.

Again, the second triangle does not overlap the second triangle. Hence, the pixels of the second triangle, having a depth Z2, are tested only against the outside mask near Z “out_Znear” and thereby resolved as visible without having to read the exact Z values, as Z2 is less than out_Znear. As a result, read bandwidth is saved while rendering both primitives.

However, this solution does not address cases with more than 2 primitives covering the same region. Also such regions have to be sufficiently large to limit total storage space and associated bandwidth. Furthermore, increase complexity and quality of the graphics scenes cause a decrease in size of each individual triangle, increasing the average number of triangles per region.

For instance, a scene with 1 million triangles per frame rendered at a resolution of 1024×768 pixels would have an average triangle size close to 1 pixel, where an 8×8 region may be covered by 16 triangles.

The main problem here is how to update both the coverage mask and the Z values associated with pixels inside and outside that mask after at least one pixel in the second primitive covering the same region is resolved as visible.

Consider an example of 3 or more triangles, having depths Z1, Z2 and Z3 respectively, rendering one after another and covering at least a part of the same 8×8 region over background Z0. The parameters stored per region after the second primitive is rendered are to be determined.

Assuming that each region is associated with a coverage mask M, the far Z values inside and outside M are “in_Zfar” and “out_Zfar”, and the Z ranges inside and outside M are “in_dZ” and “out_dZ”, wherein each Z range is the difference between the maximal and the minimal Z for all the pixels within the 8×8 region which are located, correspondingly, inside or outside M.

FIG. 1A shows an example where each triangle and the background are represented by depth profiles in the X-Z planes.

The first triangle 130 having the depth Z1 is rendered over the background 100 having a depth Z0, where Z0 is greater than Z1. Its coverage mask M is stored together with Z values inside M being “in_Zfar=Z1” and “in_dZ=0”, and outside M being “out Zfar=Z0” and “out dZ=0”. The coverage mask for the second triangle 120, having a depth Z2 where Z2 is less than Z0 and its depth values are compared with stored coverage mask and depth values.

In this example, the second triangle does not overlap the first triangle and all its pixels are recognized as visible because Z2 is less than the result of “out_Zfar−out_dZ”. Then, the stored mask M and values of “in_Zfar”, “in_dZ”, “out_Zfar” and “out_dZ” are updated and compared with the coverage mask and depth values of the third triangle 110, having a depth Z3, wherein Z3 is less than Z0, and Z3 is also less than Z2.

Results of the final comparison depend on the mask M and associated depth values stored after the second triangle is rendered.

If the stored mask M is not changed, meaning that the mask of the first triangle is kept, the “out_dZ” must be changed from 0 to “Z0-Z2”. The coverage mask of the first triangle does not overlap with M: the Z3 should be compared with stored values outside mask M. In this case “out_Zfar”−“out_dZ” is less than Z3, which in turn, is less than out_Zfar. As a result, the visibility of the pixel in the third triangle cannot be solved without the exact Z read for all its pixels.

It is predicated that if the second triangle mask is stored as M, “out_dZ” will be changed from 0 to “Z1−Z0”, because “out_Zfar”−“out-dZ” is less than Z3, which, in turn, is less than “out_Zfar”. Hence, the exact Z must be read to resolve the visibility.

However, the exact Z read can be avoided the union of the first and second triangles masks are stored as M, setting the “in_Zfar” to be Z2, the “in_dZ” to be “Z0−Z2”, the “out_Zfar” to be Z0, the “out_dZ” to be 0. Because the third triangle mask does not overlap with M, Z3 is also compared with “out_Zfar” and “out_dZ”, where Z3 is less than “out_Zfar”−“out_dZ”. From that, it can be shown that all new pixels are visible without the reading of the exact depth values.

Unfortunately, the storing of the union of the previous masks does not always produce such a satisfactory result, as shown in FIG. 1B. The second triangle 140 is rendered after the first triangle 160, where Z0 is greater than Z2, which in turn is greater than Z1. Then, the third triangle 150 is rendered on top of the second triangle, where Z2 is greater than Z3, which in turn is greater than Z1.

If the coverage mask M of the first triangle is kept after the second triangle is rendered, setting the “in_Zfar” to be Z1, the “in_dZ” to be 0, the “out_Zfar” to be Z0, the “out_dZ” to be “Z0−Z2”, the visibility of the third triangle can be resolved without having to read the exact Z, because Z3 is smaller than “out_Zfar−out_dZ”. However, if the coverage mask of the second triangle or union of two masks is stored as M, the third triangle visibility test would require the exact Z read.

Referring to FIG. 1C of the drawings, where another example is illustrated, wherein the second triangle 190 is rendered on top of the first triangle 170, where Z0 is greater than Z1, which in turn is greater than Z2. The third triangle 180 is then rendered over the first triangle, where Z1 is greater than Z3, which in turn is greater than Z2, without overlapping with the second triangle. As illustrated, the third triangle does not require the exact Z read when mask M is stored after rendering the second triangle equal to the second triangle's mask.

As shown in these examples, no pre-defined choice of updating the stored mask after rendering the second triangle is able to avoid all unnecessary exact Z read in order to resolve the visibility of the third triangle.

Therefore, a real-time method of generating per-region coverage mask and associated Z values is needed after the second primitive is rendered in the same region. This method should maximize the bandwidth savings for Z read for both overlapping and non-overlapping primitives, with different relations between their depth values.

Another drawback of known hierarchical Z methods is that they can only save Z read bandwidth, leaving the Z write bandwidth at least as high as before. The reason is that exact Z value of each visible pixel must be written to the depth buffer in order to be available if the next hierarchical Z tests for visibility in the same region cannot be resolved without it. If updated storage mask and associated Z values are stored in an external memory, Z write bandwidth may even be larger than that without hierarchical Z.

A conventional method of decreasing Z write bandwidth is Z compression, for instance, storing plane equations for multiple primitives, as disclosed in the U.S. Pat. No. 6,630,933. The effectiveness of this method reduces with an increase in the number of primitives per region.

Another method of saving Z write bandwidth, as described in the U.S. Pat. No. 6,677,945, is to decrease the amount of data stored when smaller storage size can be compensated by better precision of the depth mapping to the screen space. Bandwidth savings achieved by this method are usually less than 33%. In comparison, hierarchical Z buffer with storage masks may decrease Z read bandwidth up to more than 10 times for 8×8 regions that do not require an exact Z read.

As a result, there is a need to develop a method of saving Z write bandwidth that would work for large number of primitives per storage region, providing savings comparable with ones achieved by hierarchical methods for Z read bandwidth.

### SUMMARY OF THE PRESENT INVENTION

The main object of the present invention is to provide a method and apparatus for occlusion culling of graphic objects, it is a real-time method of generating per-region coverage mask and associated Z values after the second primitive is rendered in the same region, which can maximize the bandwidth savings for Z read for both overlapping and non-overlapping primitives, with different relations between their depth values.

Another object of the present invention is to provide a method and apparatus of occlusion culling of graphic objects for saving Z write bandwidth that would work for large number of primitives per storage region, providing savings comparable with ones achieved by hierarchical methods for Z read bandwidth.

Another object of the present invention is to provide a method and apparatus of occlusion culling of graphic objects, wherein the evaluation of the visibility of each pixel of the primitive within the region is comparing the computed depth values for the pixels of the primitive located inside and outside the first mask with the corresponding depth values stored for the first mask.

Another object of the present invention is to provide a method and apparatus of occlusion culling of graphic objects, wherein when the comparison unambiguously resolves the visibility status of each pixel of the primitive in the region, the rendering proceeds without the need to read the exact depth values previously stored in the depth buffer.

Another object of the present invention is to provide a method and apparatus of occlusion culling of graphic objects, wherein bandwidth-saving visibility evaluation for a next primitive covering the same region is enabled.

Another object of the present invention is to provide a method and apparatus of occlusion culling of graphic objects, wherein computed coverage masks and depth values for multiple new primitives covering the same region can be combined to create a common second mask and a common set of computed depth values such that their relative visibility is resolved before computed depth values are compared with depth values associated with the first mask in such a manner that a per-region mask and the associated depth values are read and updated less frequently, hence improving rendering performance.

Another object of the present invention is to provide a method and apparatus of occlusion culling of graphic objects, wherein the depth read bandwidth is reduced, especially while multiple primitives cover the same pre-defined region.

Another object of the present invention is to provide a method and apparatus of occlusion culling of graphic objects, wherein no exact depth values are written to the depth buffer while visibility evaluation is performed without reading exact depth values from the depth buffer savings of the depth write bandwidth is allowed, in addition to the depth read bandwidth.

Another object of the present invention is to provide a method and apparatus of occlusion culling of graphic objects, wherein the last depth masks and associated depth values may be reused from the first phase which has been proven to be sufficient for visibility evaluation without exact depth reads, so as to reduce the number of exact depth writes generated during the second phase.

Accordingly, in order to accomplish the above objects, the present invention provides a method of occlusion culling of graphic objects, comprising the steps of:

(a) storing a first mask and one or more depth values associated with areas inside and outside the mask for a pre-defined region, and

(b) evaluating the visibility of the primitive covering the same region, wherein visibility evaluation begins after the computation of the coverage mask of the primitive in the region, and the computation of one or more depth values representing the pixels of the primitive.

These and other objectives, features, and advantages of the present invention will become apparent from the following detailed description, the accompanying drawings, and the appended claims.

### BRIEF DESCRIPTION OF THE DRAWINGS

FIGS. 1A to 1C illustrate some prior arts of rendering three triangles represented by depth profiles in the X-Z plane, over the screen region with background Z value.

FIG. 2 illustrates a graphic object with its coverage of the single screen region and three depth masks, wherein the third mask is set to be equal to the union of the first and second masks according to a preferred embodiment of the present invention.

FIGS. 3A to 3C illustrate sequences of depth profiles in X-Z plane generated while setting the third mask to be equal to the union of the first and second masks according to the above preferred embodiment of the present invention.

FIG. 4 illustrates another graphic object with its coverage of the single screen region and three depth masks, wherein the third mask is set to be equal to the first mask according to the above preferred embodiment of the present invention.

FIGS. 5A to 5C illustrate sequences of depth profiles in X-Z plane generated while setting the third mask equal to the first mask according to the above preferred embodiment of the present invention.

FIG. 6 illustrates yet another graphic object with its coverage of the single screen region and three depth masks, wherein the third mask is set to be equal to the second mask according to the above preferred embodiment of the present invention.

FIGS. 7A to 7C illustrate sequences of depth profiles in X-Z plane generated while setting the third mask to be equal to the second mask according to the above preferred embodiment of the present invention.

FIG. 8 illustrates yet another graphic object with its coverage of the single screen region and three depth masks, wherein the second mask is computed by merging coverage masks of two triangles according to the above preferred embodiment of the present invention.

FIGS. 9A to 9E illustrate sequences of depth profiles in X-Z plane generated while the second mask is computed by merging coverage masks of 2 triangles according to the above preferred embodiment of the present invention.

FIG. 10 illustrates yet another graphic object, with its coverage of the single screen region and three depth masks, wherein the reading of exact Z values from the depth buffer is required to resolve the visibility of tested pixels according to the above preferred embodiment of the present invention.

FIGS. 11A to 11C illustrate sequences of depth profiles in X-Z plane generated while resolving the visibility of the tested pixels from exact Z values according to the above preferred embodiment of the present invention.

FIG. 12 illustrates a flow chart of the preferred embodiment of the present invention which comprises exact Z write for every visible pixel according to the above preferred embodiment of the present invention.

FIGS. 13A to 13B illustrate flow charts of the visibility evaluation using Z Mask data according to the above preferred embodiment of the present invention.

FIGS. 14A to 14B illustrate flow charts of the two phases of an alternative mode of the above preferred embodiment of the present invention, wherein the exact Z write for visible pixels is avoided while Z mask is sufficient to resolve the visibility of all tested pixels.

FIG. 15 illustrates a block diagram of the apparatus according to another alternative mode of the above preferred embodiment of the present invention.

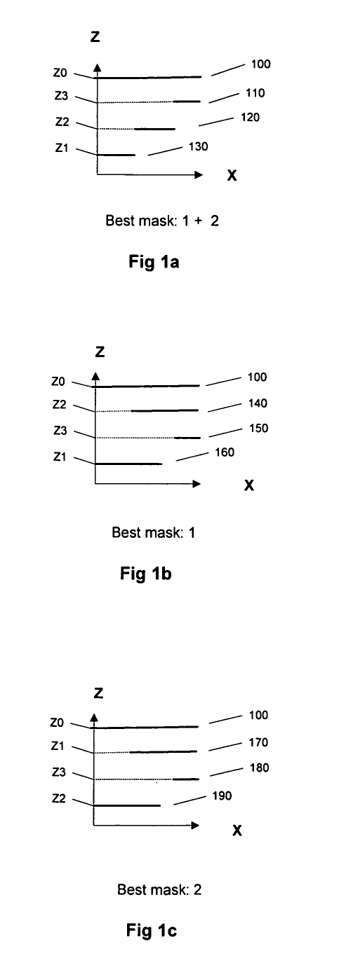

### DETAILED DESCRIPTION OF THE PREFERRED EMBODIMENT

A method of occlusion culling of graphic objects according to a preferred embodiment is illustrated, wherein the method is initiated by analyzing different combinations of the coverage masks and depth ranges of the triangles covering the same region and applying the present invention to obtain an optimal coverage mask and depth range update under different scenarios.

Before the evaluation of the visibility of a primitive covering a pre-defined region, the mask and one or more depth values associated with areas inside and outside the first mask are stored for the same region, wherein the pre-defined region can be a 4 by 4, 8 by 4 or 8 by 8 tile in the screen space. Visibility evaluation begins after the computation of the coverage mask of the primitive in the pre-defined region, which will later be referred to as the second mask, and the computation of one or more depth values representing the pixels of the primitive, for example, computing the exact depth value for every covered pixel.

The visibility of each pixel of the primitive within the region is evaluated by comparing the computed depth values for the pixels of the primitive located inside and outside the first mask with the corresponding depth values stored for the first mask. If this comparison can unambiguously resolve the visibility status of each pixel of the primitive in the region, the rendering proceeds without the need to read the exact depth values previously stored in the depth buffer.

According to the preferred embodiment of the present invention, the third mask and depth values associated with areas inside and outside that mask are generated after the first and second masks are available.

As an example, the third mask represents one or more locations inside the area covered by the first and second masks. The third mask and its associated depth values are stored in place of the first mask and its depth values, enabling bandwidth-saving visibility evaluation for the next primitives covering the region.

If the second mask contains at least one visible pixel, the computation method of the third mask can be selected from at least 3 ways as follows:

(a) Setting the third mask to be the union of the first mask and the locations of all visible pixels within the second mask;

(b) Setting the third mask to be equal to the first mask; and

(c) Setting the third mask to cover only the locations of all visible pixels of the second mask.

The first way is to be selected when the second mask does not have any common pixels with the first mask, and all generated pixels within the second mask are visible.

The second way is to be selected when the second mask has at least one pixel covered by the first mask, and none of the generated pixels covered by both first and second masks are visible.

The third way is selected when the second mask has at least one pixel covered by the first mask and all generated pixels within the second mask are visible.

Stored depth values of the first mask are used to obtain ranges of distances from the observation point for pixels inside and outside the first mask. These ranges are then compared with computed range of depth values for the pixels of the primitive while selecting one of the above mentioned ways to generate a third mask.

Specifically, the first way is selected when the second mask does not have any common pixels with the first mask, when the far depth of the first range is closer to the observation point than the near depth of the second range, and when the far depth of the third range is closer to the observation point than the average of the far depth of the first range and the near depth of the second range.

The second way is selected when each visible pixel generated inside the second mask is located outside of the first mask, when the far depth of the first range is closer to the observation point than the near depth of the second range, and when the near depth of the third range is farther from the observation point than the average between far depth of the first range and near depth of the second range.

The third way is selected when at least one visible pixel generated within the second mask is located inside the first mask, when the far depth of all visible pixels generated inside the second mask is closer to the observation point than near depth of the first range, and when the difference between near and far depth of the third range is less that the difference between far depth of the third range and the near depth for the first range.

In an alternative embodiment, the first way is selected when at least one primitive contributing to the first mask belongs to the same graphic object as at least one primitive used for computing the compute second mask, or when each visible pixel generated inside the second mask is located outside of the first mask, and no rendering state change from the pre-defined list has occurred after the previous mask read for the same region.

Instead of updating stored mask and depth values for each new primitive covering the same region, computed coverage masks and depth values for multiple new primitives covering that region can be combined to create a common second mask and a common set of computed depth values. If pixels from multiple primitives cover the same location, their relative visibility is resolved before computed depth values are compared with depth values associated with the first mask, such that a per-region mask and the associated depth values are read and updated less frequently, improving rendering performance.

As described above, the present invention deals with a reduction of the depth read bandwidth, especially while multiple primitives cover the same pre-defined region. Exact depth values for each visible pixel may still be written to the depth buffer.

In another aspect of the present invention, no exact depth values are written to the depth buffer while visibility evaluation is performed without reading exact depth values from the depth buffer.

For instance, while visibility evaluation performed by comparing the computed depth values for the pixels of the primitive with the depth values associated with areas inside and outside of the first mask is sufficient to resolve visibility of all tested pixels, no exact depth values are written to the depth buffer for visible pixels, such that all visibility tests for the scene of a selected region can be performed without reading exact depth values. The present invention allows the saving of the depth write bandwidth, in addition to the depth read bandwidth.

If at some point during the rendering process, visibility evaluation based on incomplete data, for instance, depth mask and associated depth values, is insufficient to resolve the visibility of all tested pixels in the region, exact depth values will have to be re-computed by repeating processing of preceding primitives for the same region.

Visibility evaluation is then split into two different phases, wherein the writing of exact depth values for visible pixels is disabled during the first phase but is enabled during the second phase.

In a first method, the first phase stops as soon as depth read is required for any region and the second phase includes repeated rendering in all regions. Performance gain is achieved only in cases when second phase is unnecessary. The visibility evaluation for all primitives in the entire scene can be completed without exact depth reads.

Another method is that the first phase continues until the visibility in at least one region could be evaluated without exact depth reads. During the second phase, only regions that required exact depth reads will be processed. Performance gain can be achieved even when some regions of the scene required exact depth reads, but the percentage of such regions is relatively small.

In order to reduce the number of exact depth writes generated during the second phase, last depth masks and associated depth values may be reused from the first phase which has been proven to be sufficient for visibility evaluation without exact depth reads.

In order to avoid performance degradation in cases where time spent on the second phase is greater than the time saved during the first phase, the present invention illustrates a dynamic selection of the best rendering method while rendering a sequence of graphics frames.

Depth writes savings during the first phase in the first case are evaluated in every frame. If the relative time spent on the second phase exceeds a defined threshold, primitive rendering will switch to the second method, wherein exact depth writes are performed on every visible pixel.

If the number of regions requiring exact depth reads falls below the pre-defined threshold, primitive rendering may return to the first method again.

In a third method of the present invention, frame groups using first and second methods are interleaved during the dynamic rendering of the same animated sequence. The relative number of frames in each group is adjusted, based on the relative rendering performance.

For instance, if the first method provides a better average performance, the sharing of the frames in the first group will increase. Yet, at least a small number of frames will still be rendered with the second method, such that the rendering performance is monitored. As soon as the performance of the second method increases, sharing of the frames in the second group will be increased.

In a first application example of the present invention, an updated mask combines an original mask with a new primitive coverage mask, which is typical for building a surface of a graphic object from multiple triangles.

Referring to FIG. 2 of the drawings, a graphic object—cube, is rendered on the computer screen as a sequence of triangles over a background with a constant depth. Triangles 205 are already rendered and are depicted as having thick borders. Triangle 217 is being rendered and is depicted as having a thin border. Triangles 230 are to be rendered next and are depicted as having dashed borders.

The computer screen is separated into tiles such as 235, wherein each tile contains 8×8 pixels. Tile 235 is magnified to display two coverage masks: Mask 1 (210) of the previously rendered triangle 205, Mask 2 (215) of the triangle 217 currently being rendered. It also displayed an area 240, which will be covered by the next triangle 230.

Depth profiles of triangles 205 and 217 are displayed as lines in the X-Z plane, where the depth profile 225 is the depth profile of the triangle 205 and the depth profile 220 is the depth profile of the triangle 217. In this example, coverage mask of the triangle 217 does not have any common pixels with coverage mask of triangle 205 in the region 235.

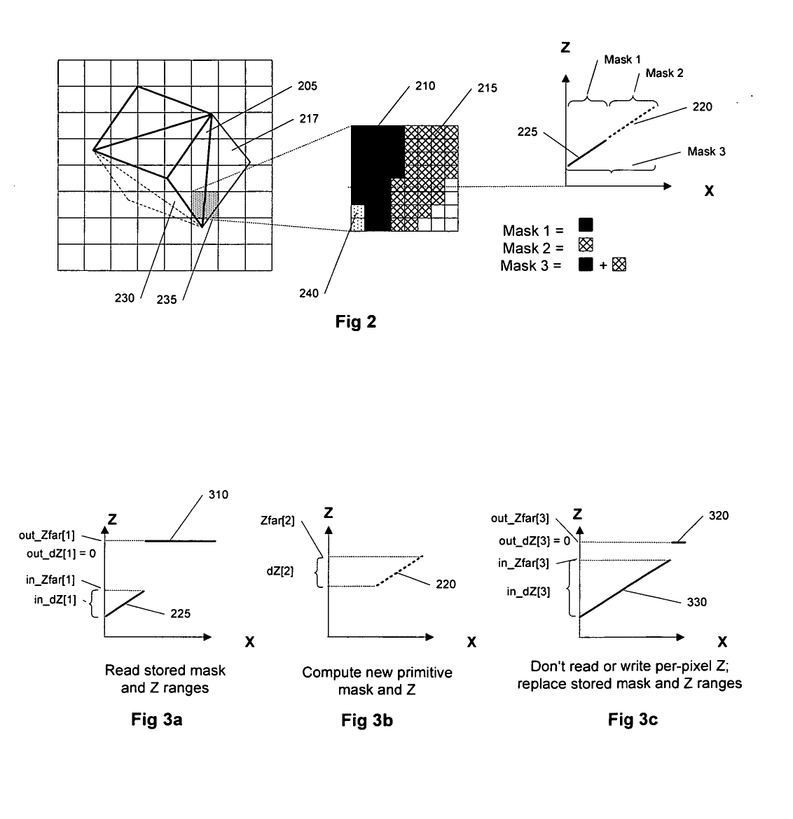

Referring to FIG. 3A of the drawings, Mask 1 is in association with depth ranges for pixels inside and outside it, wherein the “in_Zfar[1]” is the far distance to the observation point for pixels inside Mask 1, and the “in_dZ[1]” is the difference between the far and the near distances to the observation point for pixels inside Mask 1.

The “out_Zfar[1]” is a far distance to the observation point for pixels outside Mask 1, and the “out_dZ[1]” is the difference between the far and the near distances to the observation point for pixels outside Mask 1.

Similar notations are used throughout all figures depicting depth ranges, wherein an “in_” or an “out_” prefix refers to pixels inside or outside a mask respectively. When there are no prefixes, it also means “in_”. A “Zfar” and a “dZ” mean a far distance and a difference between a far and a near distance respectively. An index in brackets [I] refers to a mask index, such as [1] represents Mask 1.

Referring to FIG. 3A of the drawings, the depth range 225 is associated with the triangle 205, which is rendered over the background 310 with a constant depth of “out_Zfar[1]”.

Mask 1 and its depth ranges are stored for every processed region in a special memory, the “Zmask” buffer.

After the data of the triangle 205 in region 235 are stored in the Zmask buffer, the depth ranges of a Mask 2 of the triangle 217 are determined, as shown in FIG. 3B of the drawings.

The relationship between the depth ranges is illustrated as follows:
1. in_Zfar[1] <out-Zfar[1]−out_dZ[1] (The “in_Zfar[1]” is less than the difference between the “out_Zfar[1]” and the “out_dZ[1]”); and
2. Zfar[2]<out_Zfar[1]−out_dZ[1] (The “Zfar[2]” is less than the difference between the “out_Zfar[1]” and the “out_dZ[1]”).

Hence, it can easily be seen that the visibility of all pixels inside Mask 2 can be resolved by comparing the depth ranges of Mask 1 and Mask 2. Since all Mask 2 pixels are outside Mask 1 and (Zfar[2]<out_Zfar[1]−out_dZ[1]), all pixels inside Mask 2 are visible. As a result, reading of the exact Z values for every pixel inside Mask 2 is unnecessary, which will save on the Z read bandwidth.

The present invention then generates a Mask 3 and its associated depth values in such a manner that Z read bandwidth savings is continued, for instance, when the next triangle 230 is rendered in the same region.

According to the present invention, the detected relationship between Mask 1, Mask 2, visible pixels inside Mask 2 and the associated depth ranges generates Mask 3 to be equal to the union of Mask 1 and Mask 2 and sets the depth ranges for Mask 3, as shown in FIG. 3C of the drawings.

Pixels inside Mask 3 have a depth profile 330 having the following representation of depth ranges:
1. in_Zfar[3]=max (Zfar[2], in_Zfar[1]); and
2. in_dZ[3]=in_Zfar[3]−min(Zfar[2]−dZ[2], in_Zfar[1]−in_dZ[1]).

Pixels outside Mask 3 have depth profile 320, which, in this case, is a remainder of the background in the region 235, with the same depth representations as that of Mask 1:
1. out_Zfar[3]=out_Zfar[1] (The “out_Zfar[3]” is equal to the “out_Zfar[1]”); and
2. out_dZ[3]=out_dZ[1] (The “out_dZ[3]” is equal to the “out_dZ[1]”.

After being computed, Mask 3 and its associated depth values are stored as the Zmask buffer, as oppose to Mask 1 and its depth values. As a result of this update, the visibility of all pixels of the next triangle 230 inside the region 235, which is area 240 in FIG. 2 of the drawings, will also be resolved without an exact Z read. All of these pixels are outside Mask 3 and their depth is known to be closer than the near depth of the background, which is depicted by “out_Zfar[3]”−“out_dZ[3]”.

In a second application example of the present invention, an updated mask combines an original mask with the visible pixels of a new primitive, which is typical for rendering a graphic object partially obscured by the previously rendered object. This situation occurs most often when objects are sorted in a “front-to-back” manner.

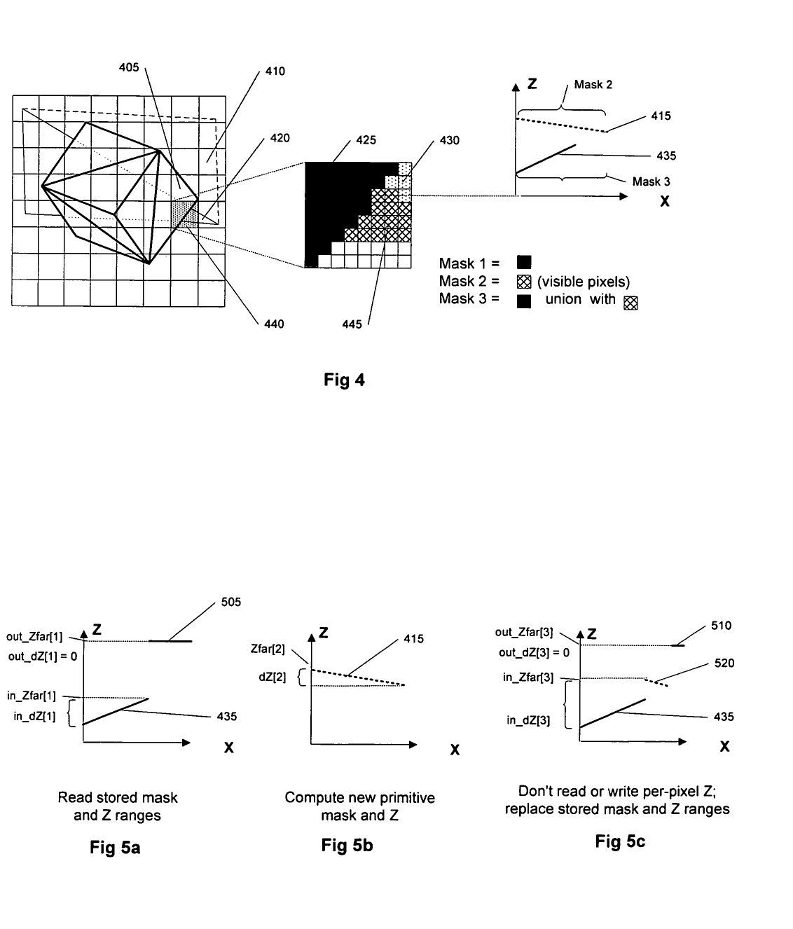

Referring to FIG. 4 of the drawings, a graphics object—cube, is first rendered on the computer screen as a sequence of triangles over the background with a constant depth. And more specifically, the triangle 405 of this object covers an 8×8 tile 440. The mask for this tile and associated depth values are stored in the Zmask buffer after the rendering of the triangle 405.

Then, another graphic object—a flat surface, is being rendered. Its triangle 420 and the next triangle 410 partially cover the same tile 440. When tile 440 is magnified, two coverage masks are displayed: Mask 1 (425) of the previously rendered triangle 405, and Mask 2 (445) of the triangle 420 being rendered, which are the visible pixels. An area 430, which will be covered by the next triangle 410, is also displayed.

Depth profiles of triangles 405 and 420 are displayed as lines in the X-Z plane, where the depth profile 435 is the depth profile of the triangle 405 and the depth profile 415 is the depth profile of the triangle 420. In this example, the coverage mask of the triangle 405 overlaps with the coverage mask of triangle 420 in the region 440.

Referring to FIG. 5a of the drawings, Mask 1 is in association with depth ranges for pixels inside (435) and outside (505) of that mask (notations are the same as those in FIG. 3a of the drawings). In this case, depth range 435 is associated with triangle 405, which is rendered over the background 505 with a constant depth “out_Zfar[1]”.

After data for triangle 405 in the region 440 are stored in the Zmask buffer, the depth ranges of Mask 2 of the triangle 420 are determined, as shown in FIG. 5b of the drawings.

The relationship between the depth ranges is illustrated as follows:
1. in_Zfar[1]<out_Zfar[1]−out_dZ[1] (The “in_Zfar[1]” is less than the difference between the “out_Zfar[1]” and the “out_dZ[1]”);
2. Zfar[2]<out_Zfar[1]−out_dZ[1] (The “Zfar[2]” is less than the difference between the “out_Zfar[1]” and the “out_dZ[1]”); and
3. Zfar[2]−dZ[2]>in_Zfar[1] (The “in_Zfar[1]” is less than the difference between the “Zfar[2]” and the “dZ[2]”).

Hence, it is apparent that that the visibility of all pixels inside Mask 2 can be resolved by comparing the depth ranges of Mask 1 and Mask 2, wherein all pixels from Mask 2 overlapping Mask 1 are hidden since “Zfar[2]”−“dZ[2]”>“in_Zfar[1]”, and all pixels from Mask 2 outside Mask 1 are visible since “Zfar[2]”<“out_Zfar[1]−out_dZ[1]”. As a result, reading of the exact Z values for every pixel inside Mask 2 is unnecessary.

The preferred embodiment of the present invention then generates Mask 3 and its associated depth values in such a manner that Z read bandwidth savings is continued, for instance, when the next triangle 410 is rendered in the same region.

According to the present invention, the detected relationship between Mask 1, Mask 2, visible pixels inside Mask 2 and the associated depth ranges generates Mask 3 to be equal to the union of Mask 1 and Mask 2 and sets the depth ranges for Mask 3, as shown in FIG. 5C of the drawings.

Pixels inside Mask 3 have a depth profile combined from one of Mask 1 (435) and from visible pixels inside Mask 2 (520), having the following representation of depth ranges:
1. in_Zfar[3]=max (visible_Zfar[2], in_Zfar[1]); and
2. in_dZ[3]=in_Zfar[3]−min (visible_Znear[3], in_dZfar[1]−in_dZ[1]).

The “visible_Zfar[2]” and the “visible_Znear[2]” are the far and the near depth values for all visible pixels in the Mask 2 respectively, such that in the case, all pixels in the area of Mask 2 are outside of Mask 1. These “visible_” values are computed by comparing the newly generated depth values for visible pixels of triangle 420 in the region 440, without accessing the Zmask buffer or the exact Z values.

Pixels outside Mask 3 have a depth profile 510, wherein in this case, it is a remainder of the background in region 440, with the same depth representations as Mask 1:
1. out_Zfar[3]=out_Zfar[1] (The “out_Zfar[3]” is equal to the “out_Zfar[1]”); and
2. out_dZ[3]=out_dZ[1] (The “out_dZ[3]” is equal to the “out_dZ[1]”).

After being computed, Mask 3 and its associated depth values are stored in the Zmask buffer, as oppose to Mask 1 and its depth values. As a result of this update, the visibility of all pixels of the next triangle 410 inside the region 440, which is area 430 in FIG. 4 of the drawings, will also be resolved without an exact Z read. All of these pixels are outside Mask 3 and their depth is known to be closer than the near depth of the background, which is depicted by “out_Zfar[3]”−“out dZ[3]”.

In a third application example of the preferred embodiment of the present invention, an updated mask covers only visible pixels of the new primitive, which is typical for rendering of a graphic object that is on top of a previously rendered object. This situation occurs most often when objects are sorted in a “back-to-front” manner.

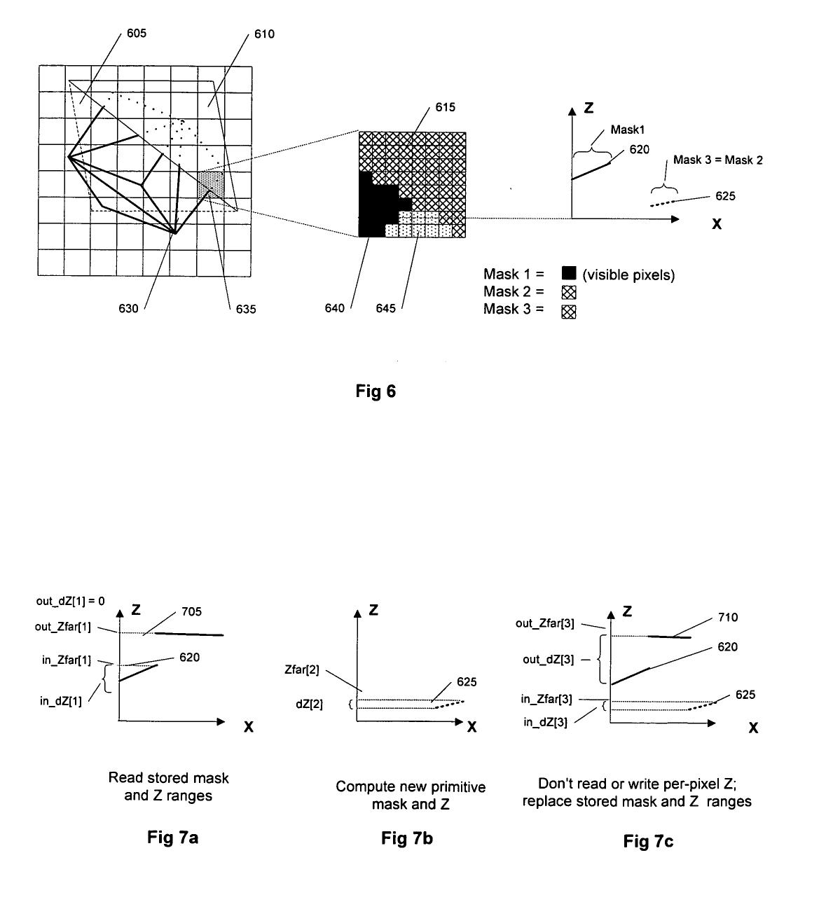

Referring to FIG. 6 of the drawings, a graphic object—cube, is first rendered on the computer screen as a sequence of triangles over the background with a constant depth. And more specifically, the triangle 630 of this object partially covers an 8×8 tile 635. The mask for this tile and associated depth values are stored in the Zmask buffer after the rendering of the triangle 630.

Then, another graphic object—a flat surface, is being rendered. Its triangle 610 and the next triangle 605 cover the same tile 635. When tile 635 is magnified, two coverage masks are displayed: Mask 1 (640) of the previously rendered triangle 630 which are the visible pixels, Mask 2 (615) of the triangle 610 being rendered. An area (645), which will be covered by the next triangle 605, is also displayed.

Depth profiles of triangles 630 and 610 are displayed as lines in the X-Z plane where the depth profile 620 is the depth profile of the triangle 630 and the depth profile 625 is the depth profile of the triangle 610. In this example, the coverage mask of the triangle 610 overlaps with the coverage mask of triangle 630 in the region 635.

Referring to FIG. 7A of the drawings, Mask 1 is in association with depth ranges for pixels inside (620) and outside (705) of that mask (notations are the same as those in FIG. 3a of the drawings). In this case, depth range 620 is associated with triangle 630, which is rendered over the background 705 with a constant depth “out_Zfar[1]”.

After data for triangle 630 in the region 635 are stored in the Zmask buffer, the depth range of the Mask 2 for triangle 610 is determined, as shown in FIG. 7B of the drawings.

The relationship between the depth ranges is illustrated as follows:
1. Zfar[2]<out_Zfar[1]−out_dZ[1] (The “Zfar[2]” is less than the difference between the “out_Zfar[1]” and the “out_dZ[1]”); and
2. Zfar[2]<in_Zfar[1]−in_dZ[1] (The “Zfar[2]” is less than the difference between the “in_Zfar[1]” and the “in_dZ[1]”).

Hence, it can easily be seen that that the visibility of all pixels inside Mask 2 can be resolved by comparing the depth ranges of Mask 1 and Mask 2, wherein all pixels from Mask 2 are visible because “Zfar[2]”<“out_Zfar[1]”−“out_dZ[1])” and “Zfar[2]”<“in_Zfar[1]”−“in_dZ[1]”. As a result, reading of the exact Z values for every pixel inside Mask 2 is unnecessary.

The preferred embodiment of the present invention then generates Mask 3 and its associated depth values in such a manner that Z read bandwidth savings is continued, for instance, when the next triangle 605 is rendered in the same region.

According to the preferred embodiment of the present invention, the detected relationship between Mask 1, Mask 2, visible pixels inside Mask 2 and associated depth ranges generates Mask 3 to cover only the visible pixels of Mask 2 (i.e., in this case, all pixels covered by Mask 2) and sets depth ranges for Mask 3, as shown in FIG. 7C of the drawings.

Pixels inside Mask 3 have a depth profile 625, which, in this case, is equal to the depth profile of Mask 2:
1. in_Zfar[3]=Zfar[2] (The “in_Zfar[3]” is equal to the “Zfar[2]”); and
2. in_dZ[3]=dZ[2] (The “in_dZ[3]” is equal to the “dZ[2]”);

Pixels outside Mask 3 have a depth profile combined from one background (710) and Mask 1 (620), having the following representation of depth ranges:
1. out_Zfar[3]=max (out Zfar[1], in Zfar[1]); and
2. out_dZ[3]=out_Zfar[3]−min (out_Zfar[1]−out_dZ[1], in_Zfar[1]−in_dZ[1]);

It should be noted that while not all pixels of the Mask 1 remain visible, full range of depth values is still to be used for pixels inside Mask 1 (in_Zfar[1], in_dZ[1]). Information stored in the Zmask buffer does not allow a decrease in this range. However, as shown below, it still allows the visibility of the next triangle in the same region to be resolved without the exact Z read.

After being computed, Mask 3 and its associated depth values are stored in the Zmask buffer, as oppose to Mask 1 and its depth values. As a result of this update, the visibility of all pixels of the next triangle 605 inside the region 635, which is area 645 in FIG. 6 of the drawings, will also be resolved without exact Z read. All of these pixels are outside Mask 3 and their depth is known to be closer than the near depth of the updated background, which is depicted by “out_Zfar[3]”−“out_dZ[3]”.

In a fourth application example of the preferred embodiment of the present invention, an updated mask combines an original mask with the coverage masks of multiple new primitives, taking the advantage of triangle coherency when a surface of the graphic object is created from multiple triangles.

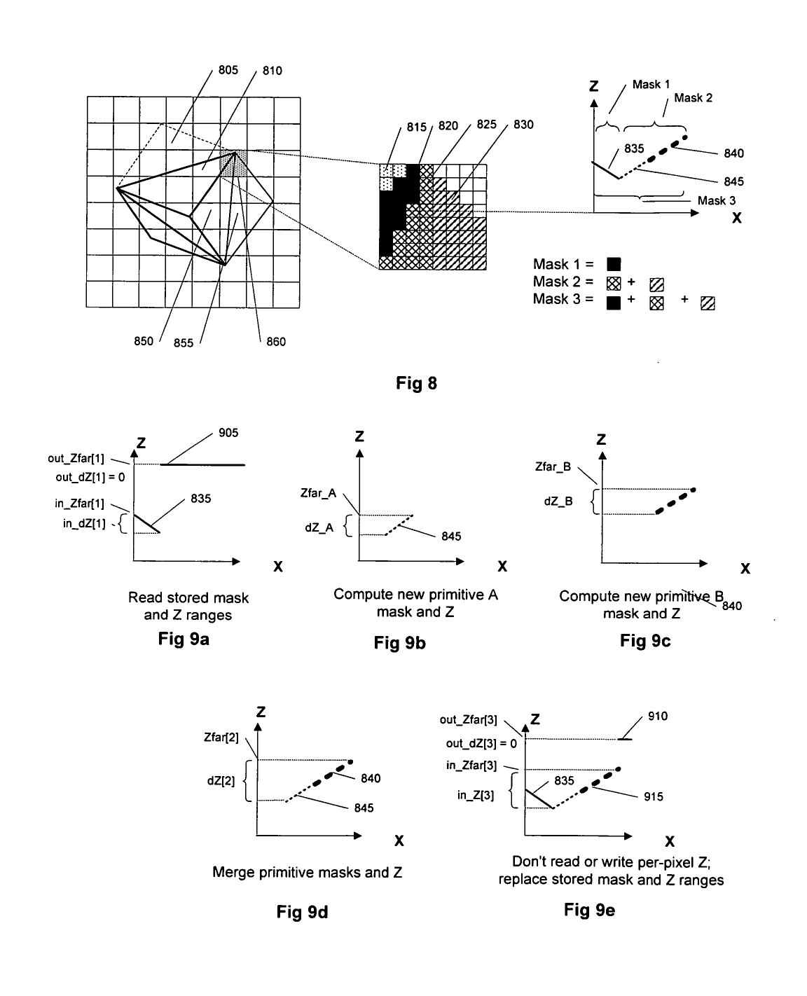

Triangles close to each other in the rendering sequence often cover the same screen region. Referring to FIG. 8 of the drawings, a graphic object—cube, is rendered on the computer screen as a sequence of triangles over the background with a constant depth. The triangle (810) which has already been rendered is depicted as having a thick border. The triangles (850 and 855) which are being rendered are depicted as having thin borders. The triangle (805) which will be next rendered is depicted as having dashed borders. The triangles 810, 850, 855 and 805 partially cover a non-overlapping area of a tile 860.

When tile 860 is magnified, three coverage masks are displayed: Mask 1 (820) of the previously rendered triangle 810, the coverage mask 825 of triangle 850 which is being rendered and the coverage mask 830 of triangle 855. The coverage mask 825 and the coverage mask 830 will later be combined to form a Mask 2. An area 815, which will be covered by the next triangle 805, is also displayed.

Depth profiles of triangles 810, 850 and 855 are displayed as lines in the X-Z plane, where the depth profile 835 is the depth profile of the triangle 810, the depth profile 845 is that of the triangle 850 and the depth profile 840 is that of the triangle 855, where the depth profile 845 and the depth profile 840 will later merge into one single depth profile.

It should be noted that in this example, two triangles (850 and 855) are being rendered simultaneously, meaning that depth values are generated for both triangles for every pixel covered inside the region 860 before the visibility evaluation is performed using values stored in the Zmask buffer.

In a first scenario under this fourth application example, each triangle is rasterized and processed as a sequence of temporary tiles, wherein each tile corresponds to an on-screen tile with a known location. Per-tile data include at least the coverage mask and newly computed exact depth values for every covered pixel, or parameters, such as start value and gradients, sufficient to reproduce these exact values.

Tiles of each triangle are temporarily stored in a “tile combiner” buffer before other operations are performed. When a new tile is generated for a current triangle, the tile combiner will perform a check whether the tile combiner has already stored a tile with the same on-screen location for a different triangle. If that is the case, the old and the new tile will be merged together to form a merged coverage mask which is a union of two masks.

At the locations where the two masks overlap, relative visibility tests will be performed using computed Z values for the same pixel of both tiles. A pixel with depth value closest to the observation point will be considered visible. The depth value of the pixel is then stored together with merged coverage mask.

In the example as shown in FIG. 8 of the drawings, the tile combiner merges masks 825 and 830 into the Mask 2.

Referring to FIG. 9A of the drawings, Mask 1 is in association with depth ranges for pixels inside (835) and outside (905) of that mask (notations are the same as those in FIG. 3a of the drawings). In this case, depth range 835 is associated with triangle 810, which is rendered over the background 905 with a constant depth “out_Zfar[1]”.

After data for triangle 810 in the region 860 are stored in the Zmask buffer, the depth ranges of a Mask 2 for the triangles 850 and 855 are determined, as shown in FIGS. 9B to 9D of the drawings.

The relationship between the depth ranges is illustrated as follows:
1. in_Zfar[1]<out_Zfar[1]−out_dZ[1] (The “in_Zfar[1]” is less than the difference between the “out_Zfar[1]” and the “out_dZ[1]”); and
2. Zfar[2]<out_Zfar[1]−out_dZ[1] (The “Zfar[2]” is less than the difference between the “out_Zfar[1]” and the “out_dZ[1]”).

Hence, it is apparent that the visibility of all pixels inside Mask 2 can be resolved by comparing the depth ranges of Mask 1 and Mask 2. Since all Mask 2 pixels are outside Mask 1, meaning that “Zfar[2]”<“out_Zfar[1]”−“out_dZ[1]”, all pixels inside Mask 2 are visible. As can be seen, it is unnecessary to read exact Z values for every pixel inside Mask 2, which in turn will save on the Z read bandwidth.

By merging same tile data for two triangles 850 and 855, visibility evaluation requires only one reading of the Zmask data for that tile instead of performing separate reading for each triangle, hence further saved on the Z read bandwidth.

The present invention generates Mask 3 and its associated depth values in such a manner that Z read bandwidth savings is continued, for instance, when the next triangle 805 is being rendered in the same region.

According to the preferred embodiment of the present invention, the detected relations between Mask 1, Mask 2, visible pixels inside Mask 2 and the associated depth ranges generates Mask 3 be equal to the union of Mask 1 and Mask 2 and sets the depth ranges for Mask 3, as shown in FIG. 9E of the drawings.

Pixels inside Mask 3 combine the depth profile 835 of Mask 1 and the depth profile 915 of Mask 2, which merged from the depth profiles 840 and 845. Wherein the depth profile 835 of Mask 3 has the following representation of depth ranges:
1. in_Zfar[3]=max (Zfar[2], in_Zfar[1]); and
2. in_dZ[3]=in_Zfar[3]−min(Zfar[2]−dZ[2], in Zfar[1]−in_dZ[1]).

Pixels outside Mask 3 have depth profile 910, which, in this case, is a remainder of the background in the region 860, with same depth representations as that of Mask 1:
1. out_Zfar[3]=out_Zfar[1] (The “out_Zfar[3]” is equal to the “out_Zfar[1]”); and
2. out_dZ[3]=out_dZ[1] (The “out_dZ[3]” is equal to the “out_dZ[1]”.

After being computed, Mask 3 and its associated depth values are stored as the Zmask buffer, as oppose to Mask 1 and its depth values. As a result of this update, visibility of all pixels of the next triangle 805 inside the region 860, which is area 815 in FIG. 2 of the drawings, will also be resolved without an exact Z read. All of these pixels are outside Mask 3 and their depth is known to be closer than the near depth of the background, which is depicted by “out_Zfar[3]”−“out_dZ[3]”.

The fifth scenario is when an updated mask is the same as the original mask, but having different depth ranges. This scenario demonstrates a scenario when the combination of a stored mask and a new coverage mask, or new coverage mask alone is used which does not produce read bandwidth savings for the next triangle.

There are three alternatives for the present invention under this scenario:

(a) the updated mask is a union of a stored mask and a new mask;

(b) the updated mask equals to a new mask;

(c) the updated mask is different from that in the above (a) or (b) alternative, for instance, the updated mark is equal to the stored mask.

This scenario also demonstrates a case where resolving visibility of new pixels requires the reading of exact depth values.

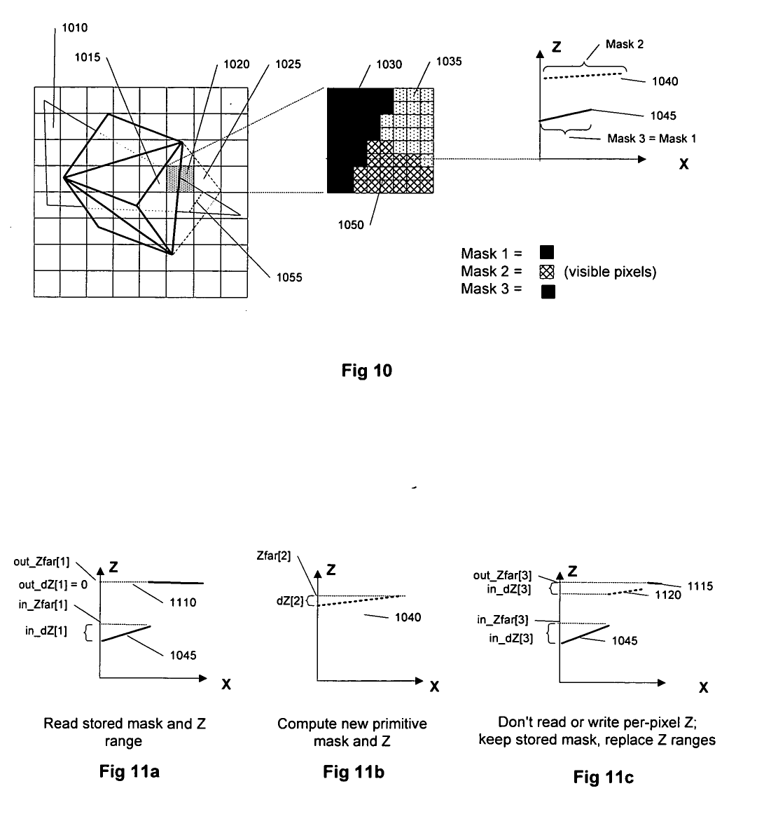

Referring to FIG. 10 of the drawings, two graphic objects are being rendered in the interleaved fashion over the background. The two graphic objects are a cube and a separate triangle 1010 that intersects it. Both the cube and triangle 1010 cover the same screen tile 1020.

First, some of the primitives of the cube, including triangle 1015 but not triangle 1025, are rendered over the background. The coverage mask and depth ranges of the triangle 1015 over the tile 1020 are stored in the Zmask buffer. After the rendering of triangles 1015 and 1025, triangle 1010 is being rendered next.

Triangle 1010 does not intersect with triangle 1015 over the tile 1020, but will be intersected later by the next triangle 1025, forming an intersection line 1055 over other tiles. After the visibility of pixels generated by the triangle 1010 inside the tile 1020 is evaluated, the coverage mask and its associated depth values must be updated for use by the next triangle 1025.

This updating of the coverage mask and its associated depth values is such that a reading of exact depth values for triangle 1025 is not required when visibility is to be resolved in the same tile.

This scenario, where different objects are rendered in the interleaved fashion, may occur, for instance, if application tries to pre-sort primitives for the “front-to-back” rendering: triangle 1015, on average, may be close to the observation point than triangle 1010, which is closer than triangle 1025.

When tile 1020 is magnified, three coverage masks are displayed: Mask 1 (1030) of the previously rendered triangle 1015, the coverage mask 1050 of triangle 1010 which is being rendered, and an area 1035 which will be covered by the next triangle 1025.

Depth profiles of triangles 1010 and 1015 are displayed as lines in the X-Z plane, where the depth profile 1040 is the depth profile of the triangle 1010 and the depth profile 1045 is that of the triangle 1015.

Referring to FIG. 11A of the drawings, Mask 1 is in association with depth ranges for pixels inside (1045) and outside (1110) of that mask (notations are the same as those in FIG. 3A of the drawings). In this case, depth range 1045 is associated with triangle 1015, which is rendered over the background 1110 with a constant depth “out_Zfar[1]”.

After data for triangle 1015 in the region 1020 are stored in the Zmask buffer, the depth range of the Mask 2 for triangle 1010 is determined, as shown on FIG. 11B of the drawings.

The relationship between the depth ranges is illustrated as follows:
1. in_Zfar[1] <out_Zfar[1]−out_dZ[1] (The “in_Zfar[1]” is less than the difference between the “out_Zfar[1]” and the “out_dZ[1]”);
2. Zfar[2]<out_Zfar[1]−out_dZ[1] (The “Zfar[2]” is less than the difference between the “out_Zfar[1]” and the “out_dZ[1]”); and
3. Zfar[2]−dZ[2] >in_Zfar[1] (The “in_Zfar[1]” is less than the difference between the “Zfar[2]” and the “dZ[2]”).

Hence, it is apparent that that the visibility of all pixels inside Mask 2 can be resolved by comparing the depth ranges of Mask 1 and Mask 2, wherein all pixels from Mask 2 overlapping Mask 1 are hidden because “Zfar[2]”−“dZ[2]”>“in_Zfar[1]”. Also, all pixels from Mask 2 outside Mask 1 are visible because “Zfar[2]”<“out_Zfar[1]”−“out_dZ[1]”. As a result, reading of the exact Z values for every pixel inside Mask 2 is unnecessary.

So far, relationship between Mask 1 and Mask 2 and their associated depth ranges are exactly the same as in the above second scenario as illustrated by FIG. 5C of the drawings, wherein the updated mask is set to be the union of the first and the second masks.

Hence, it is apparent that, under this scenario, an exact depth read will be required when the visibility of the next triangle 1025 in the area 1035 is to be resolved, the reason being that the depth of the new pixels in this area will fall within the depth range inside the stored mask.

In order to prevent new pixels from falling within the depth range inside the stored mask, in a first alternative mode under this scenario of the present invention, the updated mask will be set as the union of the two masks only if at least one primitive contributing to the stored mask belongs to the same object being rendered and used to compute the second mask. By doing so, the union of the two masks is stored only when the next primitive is expected to belong to the same object, based on the prior history for the same region.

In general, it will not make any sense if stored mask is replaced with the newly generated coverage Mask 2 since its depth range is within the range of the Mask 1.

In order to help preventing the reading of exact depth values for area 1035, stored mask 1030 is kept, while updating depth ranges only:
1. in_Zfar[3]=in_Zfar[1];
2. in_dZ[3]=in_dZ[1];
3. out_Zfar[3]=max (out_Zfar[1], Zfar[2]); and
4. out_dZ[3]=out_Zfar[3]−min(out_Zfar[1]−out_dZ[1], Zfar[2]−dZ[2]);

In other cases, best result may be achieved by storing a mask that does not equal to either the first or the second mask or the combination of both the first and the second mask.

These tests according to the preferred embodiment of the present invention, when performed on a selection of real 3D applications, show that the storing of a union of two masks or replacing a first mask with a second mask are the best choices for more than 80% of the on-screen tiles, saving Z read bandwidth for the next triangles.

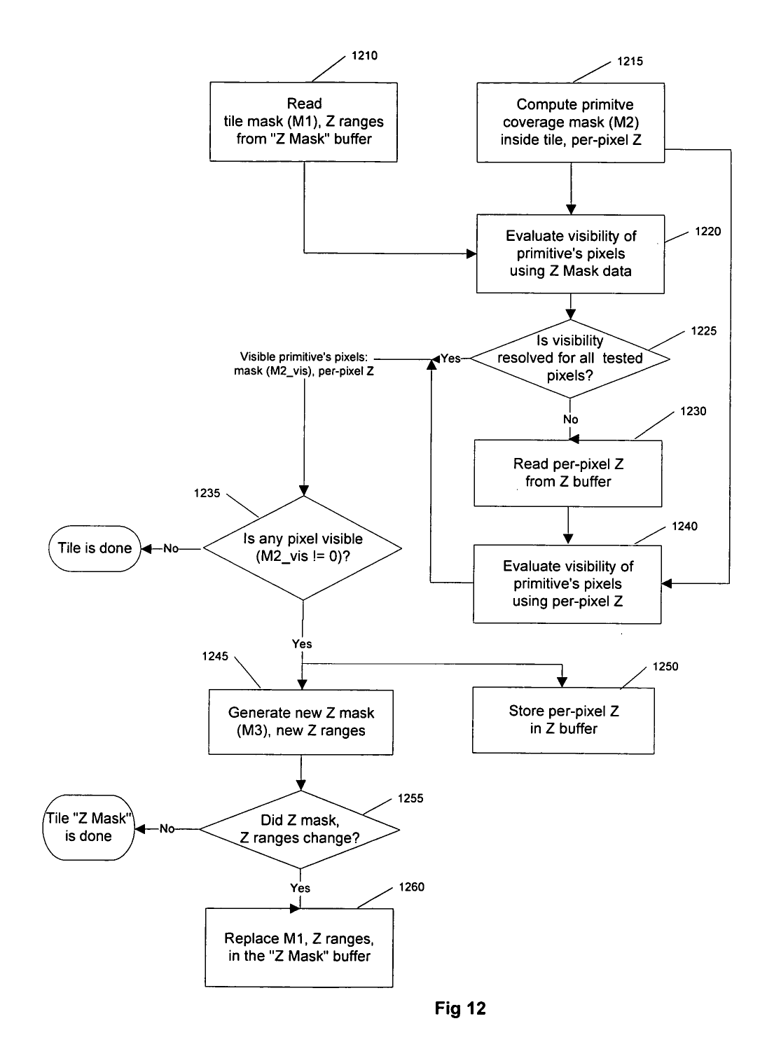

Referring to FIG. 12 of the drawings, a flow chart of the preferred embodiment of the present invention is illustrated, wherein the exact Z write for every visible pixel is accounted for.

After data are read from the Zmask buffer (1210) and new primitive data for the same region computed (1215), stored and computed data are compared to evaluate the visibility (1220). If the visibility cannot be resolved for all new pixels in M2 (decision block 1225), exact depth values are read from the depth buffer (1230) and are used for a final visibility evaluation (1240). Whether or not there is exact depth read, the visibility status for every new pixel in M2 is known.

However, if no new pixels are visible (decision block 1235), that tile is completed. Otherwise, meaning that if there are visible new pixels (decision block 1235), under this embodiment, the exact depth value for each visible pixel (1250) will be stored.

Furthermore, a new Z mask and new depth ranges are generated according to the preferred embodiment of the present invention (1245). If these data are different from that already stored in the Zmask buffer (decision block 1255), previous mask and Z ranges will then be replaced by the new ones (1260).

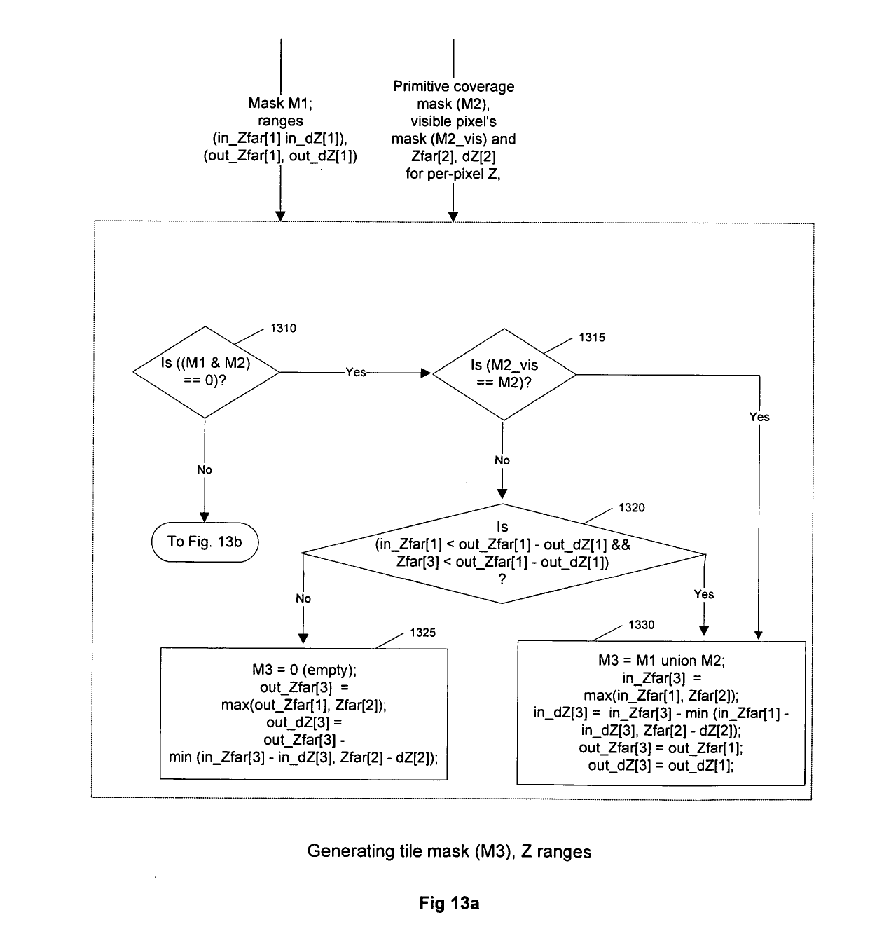

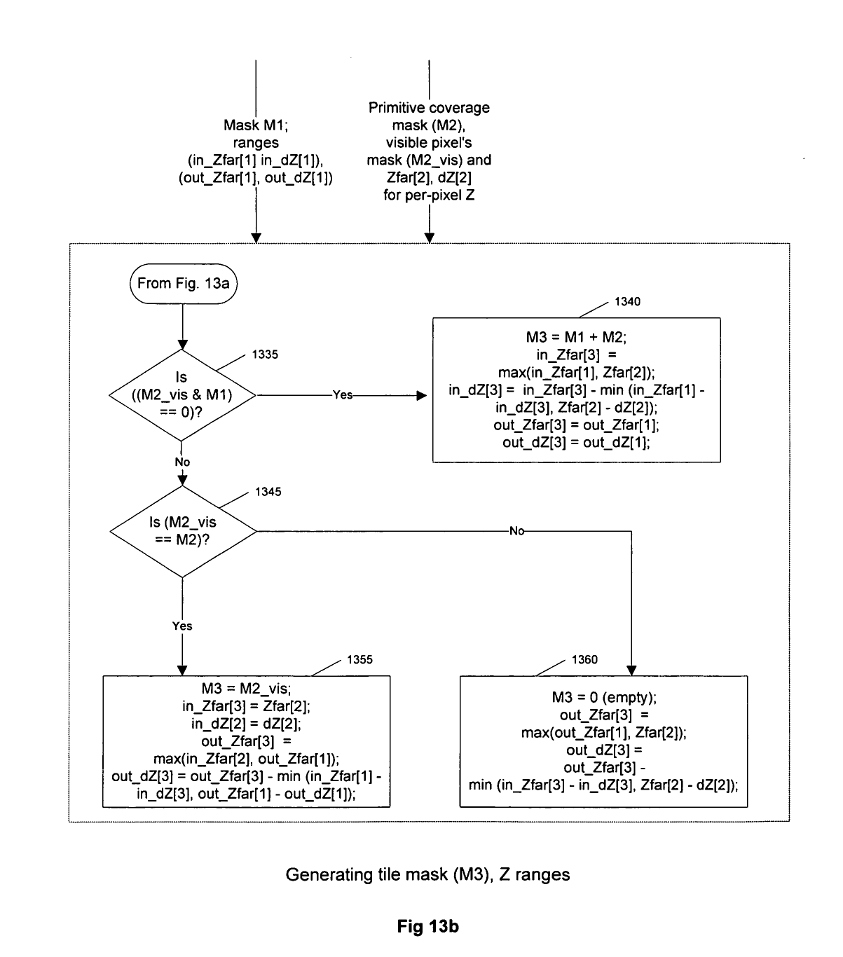

Referring to FIGS. 13A-13B of the drawings, flow charts of the visibility evaluation using Z Mask data according to the preferred embodiment of the present invention is illustrated, wherein the functionality of the module 1245 of the FIG. 12 of the drawings is explained.

Referring to FIG. 13A of the drawings, decision block 1310 within the module 1245 provides a test of whether or not M2 has any common pixels with M1. If M2 has common pixels with M1, wherein all generated pixels inside M2 are visible (decision block 1315), the mask will be updated to M3, which is equal to the sum of M1 and M2. The depth ranges will be computed in such a manner as shown in module 1330.

If decision block 1315 returns a negative result, block 1320 will then check the depth ranges. If the test result is true, the mask and the depth range will be updated also according to block 1330.

If the result after block 1320 is false, the present invention directs the use of some other unspecified option. According to this embodiment of the present invention, control is then phased to block 1325 after a false result has been returned by block 1320, which resets mask M3 to an empty value, storing depth range that encomphases both M1 and M2.

Referring to FIG. 13B of the drawings, processing continues in a case where M1 and M2 have at least one common pixel. If all new pixels overlapping M1 are invisible (decision block 1335), block 1340 computes M3 as a union of M1 and M2, with corresponding update of the depth ranges.

In the case where not all new pixels inside M1 are invisible, decision block 1345 will test if all new pixels are visible. If the result is positive, block 1355 updates mask M3 to be equal to the coverage mask M2, with the same depth range inside and updated depth range outside.

In the case where some, but not all, of the new pixels inside M1 are invisible, this embodiment of the present invention directs the use of some other unspecified option. According to this embodiment, control is then phased to the block 1360, which resets stored mask M3 to an empty value, storing depth range that encomphases both M1 and M2.

The present invention, as illustrated above, achieves the objective of decreasing Z read bandwidth when multiple primitives cover a same region.

Another objective of the present invention, as illustrated below, is to decrease Z write bandwidth. According to the preferred embodiment of the present invention, no exact depth values are written to the depth buffer while visibility evaluation is performed without reading exact depth values from the depth buffer.

For instance, while a visibility evaluation, performed by comparing computed depth values for pixels of the primitive with depth values associated with areas inside and outside of the first mask, is sufficient to resolve the visibility of all tested pixels, no exact depth values are written to the depth buffer for visible pixels, such that when all visibility tests for the scene of a selected region can be performed without having to read the exact depth values. The present invention allows the saving of depth write bandwidth in addition to the depth read bandwidth.

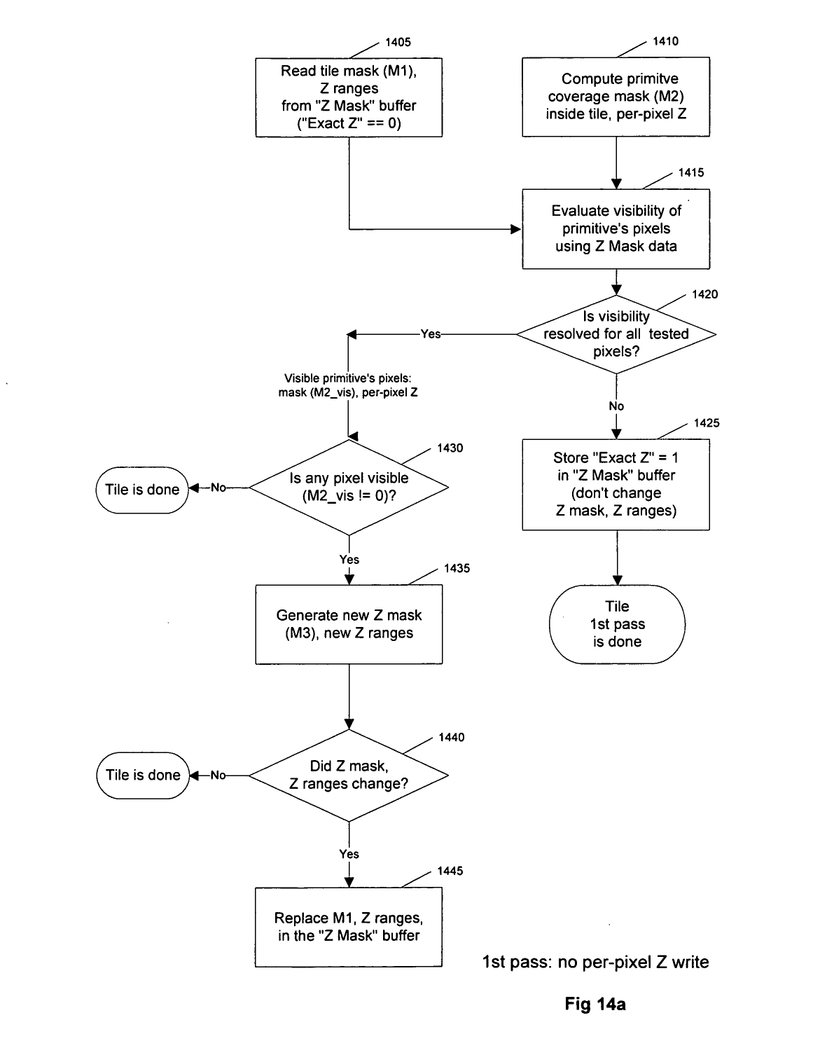

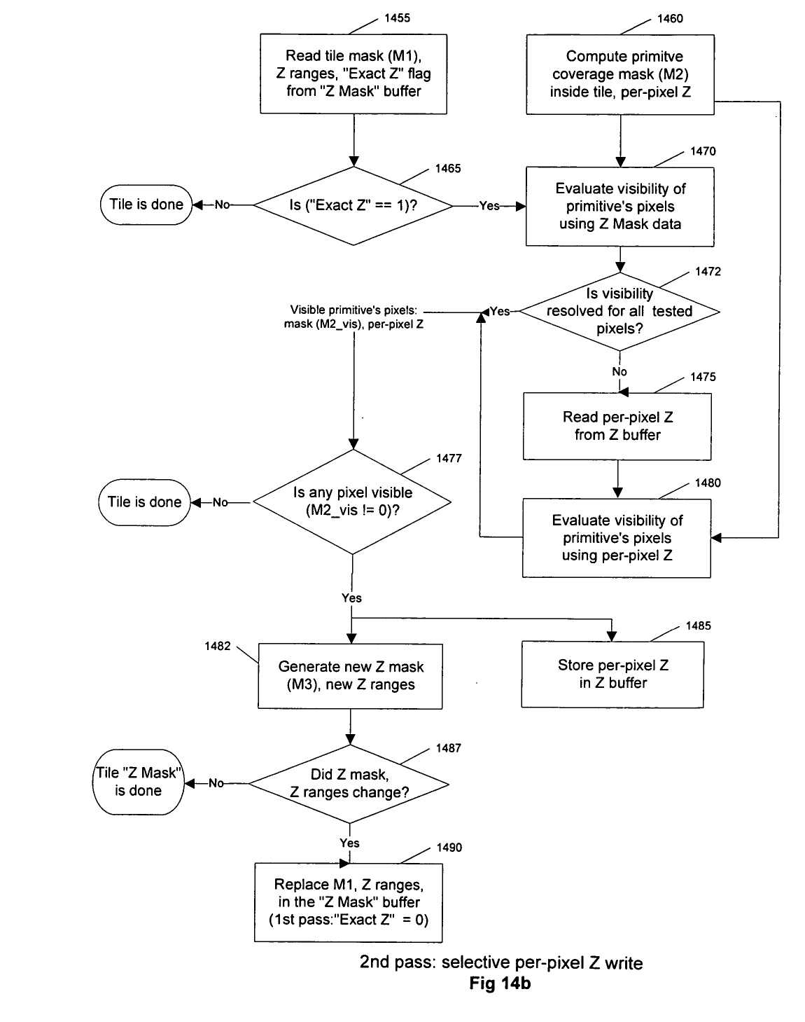

Referring to FIG. 14A of the drawings, block 1415 evaluates the visibility of the pixels of the new primitive by comparing their computed depth values (1410) with the stored mask and the Z ranges, which is read from Zmask buffer (1405). The Zmask buffer according to this alternative mode also contains a flag “Exact Z”, used for identifying tiles subject to the second phase. The flag is initially set to be 0.

If visibility can be resolved for all tested pixels (decision block 1420), rendering a proceed as in the above example, as shown in FIG. 12 of the drawings, with the only difference that exact Z values are not written to the depth buffer.

If Zmask is not enough to resolve the visibility of all tested pixels, processing of the current tile during the first phase will be terminated in such a manner that the flag “Exact Z” will be set to 1 by block 1425 to indicate that this tile is subject to the second phase.

Second phase will at least be performed on primitives having tiles with “ExactZ=1”. Referring to Fig.14B of the drawings, it starts by reading data from Zmask buffer for the current tile, which is essentially one that is covered by the current primitive with depth values computed by block 1460.

If the tile was processed completely during the first phase, without ever reading or writing an exact depth value, its “Exact Z” flag remains 0 and decision block 1465 will hold the processing during the second phase.

Otherwise, when “Exact Z” flag is 1, processing of the tile will proceed according to FIG. 12 of the drawings, in such a manner that exact Z values is read from the depth buffer when necessary and written out for all visible pixels.

According to the preferred embodiment of the present invention, both read and write bandwidth savings are achieved if only a relatively small number of tiles require exact depth values to resolve the visibility of all pixels, for instance, if some tiles contain intersections of two or more primitives, as shown in FIG. 10 of the drawings. Usually, the percentage of such tiles is relatively small.

Another instance where exact depth read can be required is when Zmask was not efficiently updated to be sufficient for the next primitives. As a result, efficiency of an objective of the present invention (decreasing Z write bandwidth) depends on the efficiency of another objective, which is the optimal update of the mask and associated depth values in the Zmask buffer.

The objective of the invention describes efficient Zmask updates for two main scenarios. These two scenarios cover a majority of tiles in typical graphics application, wherein new primitives belong to the same surface as the old ones in the sequence, and the new one is constructed above the old one.

In many graphic scenes without intersecting primitives, all tiles can be rendered without any reading or writing of the exact depth values. If the percentage of frames requiring an exact depth read is small, for instance, below 5%, marking of the tiles and primitives with “Exact Z” flag may not be necessary. However, if any tile requires an exact depth read, the second phase may re-render the entire scene.

In order to decrease the number of exact depth writes generated during the second phase, last depth masks and their associated depth values from the first phase that proved to be sufficient for visibility evaluation without exact depth reads may be reused.

In order to avoid performance degradation in cases where time spent on the second phase is greater than time saved during the first phase, the present invention describes a dynamic selection of the best rendering method while rendering sequence of graphic frames.

According to another alternative mode of the preferred embodiment of the present invention, savings by the first rendering method that avoids depth writes during the first phase are evaluated for every frame, such that when the relative time spent on the second phase exceeds a pre-defined threshold, rendering will be switched to a second method, such that exact depth writes are performed for every visible pixel. If the number of regions requiring exact depth reads falls below the pre-defined threshold, rendering will be switched back to the first method.

According to yet another alternative mode of the preferred embodiment of the present invention, frame groups using the first and second rendering methods are interleaved during dynamic rendering of the same animated sequence, where the relative number of frames in each group is adjusted based on the relative rendering performance.

For instance, if the first rendering method provides a better average performance, sharing of the frames in the first group will increase. However, at least a small number of the frames are still being rendered using the second rendering method, so as to monitor its performance. As soon as performance of the second rendering method increases, the application will increase the sharing of the frames in the second group.

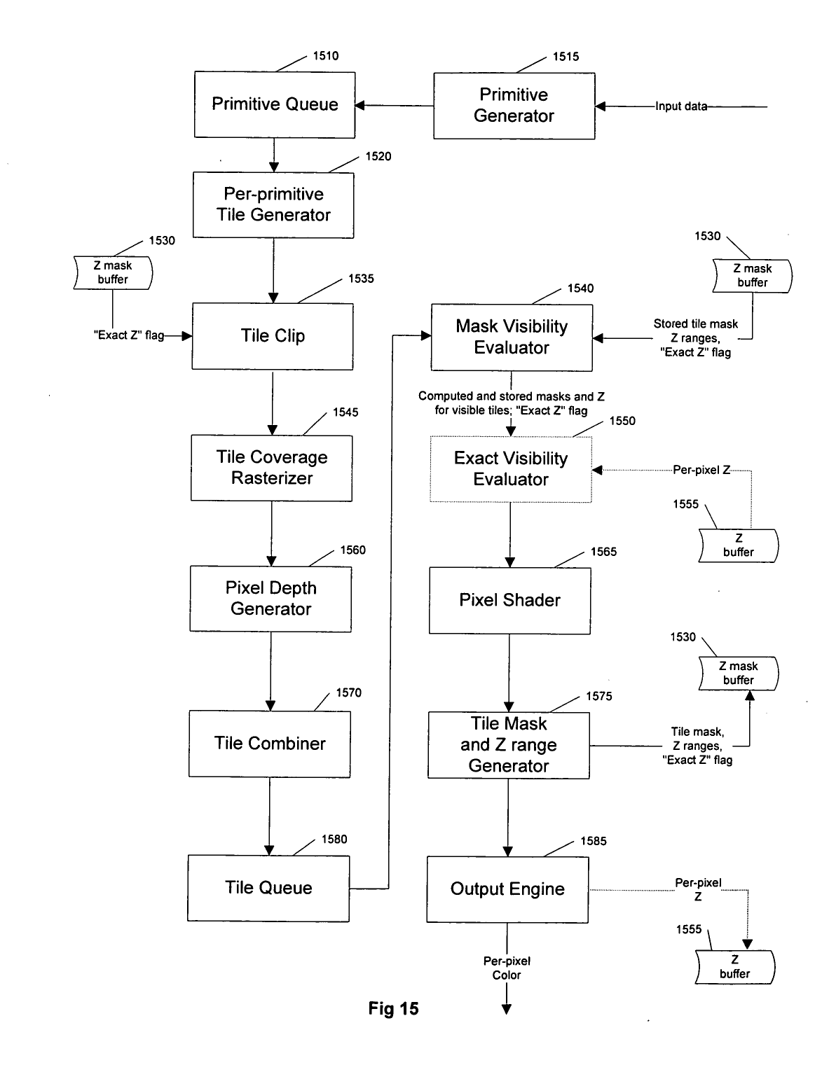

Referring to FIG. 15 of the drawings, a block diagram of the apparatus according to another alternative mode of the preferred embodiment of the invention is illustrated. Input geometry data, including XYZ vertex coordinates, are received by the primitive generator 1515. The resulting per-primitive vertex groups are accumulated in the primitive queue (1520).

Each primitive is first processed by the per-primitive tile generator (1520), rasterizing primitive into a sequence of tile, for instance, each 8×8 pixels. Some tiles are rejected by the tile clip (1535), as it is outside of the viewport.

The tile clip also reads “Exact Z” flag from the Zmask buffer 1530. During the first phase, where there is no exact depth write required, the tile clip rejects all tiles with “Exact Z”=1, wherein exact depth values is required. During the second phase, the tile clip rejects all tiles with “Exact Z”==0, wherein re-computation is not required.

Accepted tiles are sent to Tile Coverage Rasterizer (1545), which, together with Pixel Depth generator (1560), computes coverage mask for every tile and depth value for every pixel.

Tile data are then sent to the tile combiner (1545), which allocates a place for the tile data in the tile queue (1560). When a new tile is received, tile combiner checks if the tile queue already stores a tile with the same on-screen location for a different triangle. If that is the case, the old and the new tile will be merged together, wherein the merged coverage mask is a union of 2 masks.

Furthermore, at locations where 2 masks overlap, relative visibility test is performed using computed Z values for the same pixel in both tiles. The pixel with a depth value closest to the observation point will be considered visible, where its depth value will be stored together with merged coverage mask.

Merged tile data for the current primitive arrive to the Mask Visibility Evaluator (1540), which compares them with the values already stored in the Zmask buffer (1530). If Zmask data are not sufficient to evaluate visibility of all pixels in the tile, “Exact Z” flag for that tile is set to 1.

During the first phase, all tiles with any “Exact Z” value are immediately phased to the pixel shader (1565) without any exact depth values reading, and then to a Tile Mask And Z range Generator (1575).

Block 1575 updates and stores mask and Z ranges according to the present invention, together with “Exact Z” flag as the Zmask buffer (1530). During the first phase, if “Exact Z”=1, tile processing is terminated without further output, such that all other tiles with the same coordinates will be rejected by the tile clip until the second phase. Tiles in the first phase with “Exact Z”=0 reaches an output engine (1585) which stores a final per-pixel color without writing exact depth values.

During the second phase, tiles without sufficient Zmask data for resolving visibility of all pixels are sent to the exact visibility evaluator (1550), which requests exact depth values from the Z buffer (1555). During this phase, the output engine stores both the per-pixel color and the exact depth value for each visible pixel.

It is worth to mention that the present invention is not limited to the described embodiments. More specifically, the second objective of the present invention can be applied to any compact or incomplete representation of a depth buffer that is stored in addition to exact depth values.

For instance, if compact representation stores compressed depth data using a limited number of plane equations, as long as already stored compact representation is sufficient to resolve visibility of all pixels, no exact depth writes are required for visible pixels. Tiles where this representation is insufficient, for instance, the number of triangles covering the same tile exceeds a pre-defined limit, will be re-computed during the second phase.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encomphased within the spirit and scope of the following claims.

What is claimed is:

1. A method of occlusion culling of graphics primitives covering at least a region of a tile, comprising the steps of:
(a) storing a first mask and one or more depth values associated with areas inside and outside said first mask for said region of said tile; and
(b) evaluating a visibility of primitives covering said region after computing a coverage mask of said primitives covering said region and computing said one or more depth values representing pixels of each said primitive.

2. The method, as recited in claim 1, before the step (a), further comprising a step of:
(a-1) determining said first mask from one of said graphics primitives in said region and Z-values as said depth values of said first mask associated with said pixels inside and outside said first mask within said region.

3. The method, as recited in claim 2, wherein in the step (a), said first mask and said Z-values thereof are stored as a Z-mask buffer.

4. The method, as recited in claim 3, before the step (b), further comprising a step of:
(b-1) determining a second mask from another graphics primitive in said region and Z-values of said second mask.

5. The method, as recited in claim 4, wherein after the step (b), further comprising the steps of:
(c) evaluating said visibility of pixels inside said second mask by comparing said Z-values of said second mask with said Z-mask buffer;
(d) determining a third mask for said pixels covered by said first and second masks within said region and a Z-value of said third mask associated with said pixels inside and outside said third mask within said region; and
(e) storing said third mask and said Z-values thereof as an updated Z-mask buffer and said Z-value thereof for said region to update said visibility of said pixels so as to enable a bandwidth-saving visibility evaluation for next primitives coving said region.

6. The method, as recited in claim 5, wherein in step (c), when said evaluation is succeeded in resolving visibility of said pixels, said visible pixels are rendered without reading said Z-mask buffer.

7. The method, as recited in claim 6, wherein in the step (d), when said second mask contains no common pixel with said first mask, said third mask is set to be the union of said first mask and locations of said visible pixel inside said second mask.

8. The method, as recited in claim 6, wherein in the step (d), when said pixel inside said second mask is visible, said third mask is set to be the union of said first mask and locations of said visible pixel inside said second mask.

9. The method, as recited in claim 6, wherein in the step (d), when at least one pixel of said second mask is covered by said first mask and none of said pixels covered by said first and second masks are visible, said third mask is set to be the union of said first mask and locations of said visible pixel inside said second mask.

10. The method, as recited in claim 6, wherein in the step (d), when at least one pixel of said second mask is covered by said first mask and said pixel inside said second mask is visible, said third mask is set to cover locations of said visible pixel of said second mask.

11. The method, as recited in one of claims 5, 6, 7, 8, 9, and 10, wherein the step (d) further comprises the steps of:
(d.1) obtaining a first range of Z-value for said pixels inside said first mask and a second range of Z-value for said pixels outside said first mask;
(d.2) obtaining a third range of Z-value for said pixels covered by said second mask; and
(d.3) comparing said ranges between said first and second masks while determining said third mask.

12. A method for occlusion culling of graphics primitives covering one or more pre-defined regions, comprising the steps of:
(a) for at least one region, computing and storing a first mask and one or more first depth values associated with areas inside and outside said first mask;
(b) after said first mask is computed, computing a second mask representing a region having coverage by one or more primitives, and computing one or more second depth values representing pixels generated by said primitives;
(c) evaluating a visibility of generated pixels by comparing said computed second depth values with said first depth values associated with said first mask;
(d) proceeding to render visible tested pixels without reading stored depth values for each of tested pixels from a depth buffer if the evaluating step (c) has succeeded in resolving visibility of said tested pixels;
(e) computing a third mask representing one or more locations inside an area covered by said first and second masks if said evaluating step (c) has succeeded in resolving visibility of all said tested pixels;
(f) computing one or more third depth values associated with areas inside and outside said third mask; and
(g) storing said third mask and associated depth values in place of said first mask and stored depth values thereof for said region, thereby enabling bandwidth-saving visibility evaluation for next primitives covering said region.

13. The method, as recited in claim 12, wherein said second mask contains at least one visible pixel and the step (e) further comprises a step of creating said third mask equal to a union of said first mask and locations of all said visible pixels inside said second mask when said second mask doesn't have common pixels with said first mask.

14. The method, as recited in claim 12, wherein said second mask contains at least one visible pixel and the step (e) further comprises a step of creating said third mask equal to a union of said first mask and locations of all said visible pixels inside said second mask when said second mask has at least one pixel covered by said first mask.

15. The method, as recited in claim 12, wherein said second mask contains at least one visible pixel and the step (e) further comprises a step of creating said third mask equal to a union of said first mask and locations of all said visible pixels inside said second mask when none of said generated pixels covered by both said first and second masks are visible.

16. The method, as recited in claim 12, wherein said second mask contains at least one visible pixel and the step (e) further comprises a step of creating said third mask that covers only locations of all said visible pixels of said second mask when all said generated pixels inside said second mask are visible.

17. The method, as recited in claim 12, wherein said second mask contains at least one visible pixel and the step (e) further comprises a step of creating said third mask that covers only locations of all said visible pixels of said second mask when said second mask has at least one pixel covered by said first mask.

18. The method, as recited in claim 12, wherein said second mask contains at least one visible pixel and the step (e) further comprises a step of creating said third mask that covers only locations of all said visible pixels of said second mask when all said generated pixels inside said second mask are visible.

19. The method, as recited in claim 12, wherein said second mask contains at least one visible pixel and the step (e) further comprises a step of creating a third mask that is different from any mask which is created to equal to a union of said first mask and locations of all said visible pixels inside said second mask or covers only locations of all said visible pixels of said second mask.

20. The method, as recited in claim 12, further comprising the steps of:
(h) from said stored said depth values associated said first mask, obtaining a first range of depth values for said pixels inside said first mask and a second range of depth values for said pixels outside said first mask;
(i) obtaining a third range of said depth values for one or more said generated pixels covered by said second mask; and
(j) comparing said depth ranges obtained for said first and second masks while computing said third mask.

21. The method, as recited in claim 20, wherein said second mask contains at least one visible pixel and the step (e) further comprises a step of creating said third mask equal to a union of said first mask and locations of all said visible pixels inside said second mask when said second mask doesn't have said visible pixels covered by said first mask.

22. The method, as recited in claim 20, wherein said second mask contains at least one visible pixel and the step (e) further comprises a step of creating said third mask equal to a union of said first mask and locations of all said visible pixels inside said second mask when a far depth of said first range is closer to a observation point than a near depth of said second range.

23. The method, as recited in claim 20, wherein said second mask contains at least one visible pixel and the step (e) further comprises a step of creating said third mask equal to a union of said first mask and locations of all said visible pixels inside said second mask when a far depth of said third range is closer to a observation point than a near depth of said second range.

24. The method, as recited in claim 20, wherein said second mask contains at least one visible pixel and the step (e) further comprises a step of creating said third mask that covers only locations of all said visible pixels of said second mask when at least one said visible pixel generated inside said second mask is located inside said first mask.

25. The method, as recited in claim 20, wherein said second mask contains at least one visible pixel and the step (e) further comprises a step of creating said third mask that covers only locations of all said visible pixels of said second mask when a far depth of all said visible pixels generated inside said second mask is closer to a observation point than a near depth of said first range.

26. The method, as recited in claim 20, wherein said second mask contains at least one visible pixel and the step (e) further comprises a step of creating said third mask that covers only locations of all said visible pixels of said second mask when a far depth of all said visible pixels generated inside said second mask is closer to a observation point than a near depth of said second range.

27. The method, as recited in claim 12, wherein the step (e) further comprises the steps of:
(e.1) evaluating type of at least one said primitive that contributed to said stored first mask and said depth values thereof; and
(e.2) comparing said type with another type of at least one said primitive used to compute said second mask and said depth values thereof.

28. The method, as recited in claim 27, wherein said second mask contains at least one visible pixel and the step (e) further comprises a step of creating said third mask equal to a union of said first mask and locations of all said visible pixels inside said second mask when at least one said primitive contributing to said first mask belongs to the same graphics object as at least one said primitive used to compute said second mask.

29. The method, as recited in claim 27, wherein said second mask contains at least one visible pixel and the step (e) further comprises a step of creating said third mask equal to a union of said first mask and locations of all said visible pixels inside said second mask when each said visible pixel generated inside said second mask is located outside of said first mask.

30. The method, as recited in claim 27, wherein said second mask contains at least one visible pixel and the step (e) further comprises a step of creating said third mask equal to a union of said first mask and locations of all said visible pixels inside said second mask when no rendering state change from said pre-defined list has occurred after a previous mask read for the same region.

31. The method, as recited in claim 12, wherein said pre-defined region is a rectangular tile in a set of tiles covering a rendering scene.

32. The method, as recited in claim 31, wherein each said tile occupies rectangle with a size selected from a group consisting of 4 by 4 pixels, 4 by 8 pixels and 8 by 8 pixels.

33. The method, as recited in claim 12, wherein in the step (b), said second mask represents said region having coverage by at least two primitives and the step (b) further comprises the steps of:
(b.1) computing a first coverage mask and depth values for pixels generated by said first primitive;
(b.2) computing a second coverage mask and depth values for pixels generated by said second primitive;
(b.3) merging said first and second coverage masks of said first and second primitives; and
(b.4) for locations contained in both said first and second coverage masks, selecting a depth value closest to a observation point from said depth values for said pixels at locations generated by both said first and second primitives.

34. A method of occlusion culling of graphics primitive in a sequence of primitives covering one or more pre-defined regions, comprising the steps of:
(a) for at least one region, storing a compact representation of a depth buffer, wherein said compact representation is smaller in size than one required to store exact depth values for all pixels in said region;
(b) computing one or more depth values representing depth values of a primitive inside said region to obtain computed depth values;
(c) evaluating visibility of pixels of said primitive inside said region by comparing said computed depth values with said exact depth values obtained from stored representation; and
(d) if a visibility evaluation in the step (c) is sufficient to resolve visibility of all said pixels being tested, updating said compact representation of said depth buffer and evaluating visibility of one or more subsequent primitives without first storing said exact depth values in said depth buffer, thereby avoiding both reading and writing of said exact depth values for said regions having sufficient data for visibility testing.

35. The method, as recited in claim 34, further comprising the steps of:
(e) if said visibility evaluation in the step (c) fails to resolve visibility of all said pixels being tested, re-computing depth values for one or more preceding primitives to obtain a value to be used resolve visibility of said pixels being tested.

36. The method, as recited in claim 34, wherein the step (a) comprises a step of:
(a.1) storing representations of a mask inside said region and of one or more depth values associated with areas inside and outside said mask.

37. The method, as recited in claim 36, wherein the step (c) comprises the steps of:
(c.1) from said compact representations of said depth values stored with said mask, obtaining a first range of depth values for each of said pixels inside said mask and a second range of depth values for each of said pixels outside said mask;
(c.2) evaluating visibility of said pixel of said primitive inside said mask by comparing said depth values thereof with said first depth range; and
(c.3) evaluating visibility of said pixel of said primitive outside said mask by comparing said depth values thereof with said second depth range.

38. The method, as recited in claim 35, further comprising the steps of:
(f) identifying one or more regions where evaluation based on said compact representation failed to resolve visibility of all said pixels being tested;
(g) completing pre-defined stage of visibility testing for one or more regions where evaluation based on said compact representation was sufficient to resolve visibility; and
(h) re-computing and storing exact depth values for said pixels in said regions being identified before performing repeated visibility testing, without storing said exact depth values for said regions where said visibility testing was already completed.

39. The method, as recited in claim 37, further comprising the steps of:
(f) identifying one or more regions where evaluation based on said compact representation failed to resolve visibility of all said pixels being tested;
(g) completing pre-defined stage of visibility testing for one or more regions where evaluation based on said compact representation was sufficient to resolve visibility; and
(h) re-computing and storing exact depth values for said pixels in said regions being identified before performing repeated visibility testing, without storing said exact depth values for said regions where said visibility testing was already completed.

40. The method, as recited in claim 39, wherein said exact depth values for said regions being identified are re-computed after completing said pre-defined stage of visibility testing for all said regions where evaluation based on said compact representation was sufficient to resolve visibility.

41. The method, as recited in claim 35, further comprising the steps of:
(f-1) detecting if evaluation based on said compact representation failed to resolve visibility of all said pixels being tested in at least one region on a screen;
(f-2) if detected, re-computing and storing said exact depth values for all said regions composing said scene; and
(f-3) else proceeding to a next scene without creating exact depth buffer for a current scene.

42. The method, as recited in claim 35, further comprising the steps of:
(f-1) if evaluation based on said compact representation fails to resolve visibility of all said pixels being tested for said primitive covering said region, stopping updates of said compact representation for said region until exact depth values for at least some of said pixels being tested are recomputed by processing said preceding primitives; and
(f-2) while performing repeated visibility evaluation for said primitives being recomputed, using said compact representation being latest stored that was sufficient to resolve visibility of all said pixels be re-tested, thereby decreasing both reading and writing of said exact depth values during said repeated visibility evaluation.

43. The method, as recited in claim 41, further comprising the steps of:
(f-4) if evaluation based on said compact representation fails to resolve visibility of all said pixels being tested for said primitive covering said region, stopping updates of said compact representation for said region until exact depth values for at least some of said pixels being tested are recomputed by processing said preceding primitives; and
(f-5) while performing repeated visibility evaluation for said primitives being recomputed, using said compact representation being latest stored that was sufficient to resolve visibility of all said pixels be re-tested, thereby decreasing both reading and writing of said exact depth values during said repeated visibility evaluation.

44. The method, as recited in claim 43, further comprising the steps of:
(g) evaluating effect of said visibility evaluation of the steps (f-1) to (f-3) on a performance of a rendering process, where exact depth buffer writes are not performed while visibility of all said pixels to be tested are able to be resolved from said compact representation of said depth buffer.

45. The method, as recited in claim 44, further comprising a step of:
(j) continuing to proceed the step (f-1) to step (f-3) for one or more regions if resulting performance improvement outweighs performance decrease due to re-computations.

46. The method, as recited in claim 44, further comprising a step of:
(j) switching to the steps (f-4) to (f-5), where exact depth buffer writes are performed even if visibility of all said pixels being tested are able to be resolved from said compact representation of said depth buffer.

47. The method, as recited in claim 46, further comprising the step of:
(k) after switching to the steps (f-4) to (f-5), periodically proceeding the steps (f-1) to (f-3) again and comparing said performance thereof with a resulting performance of the steps (f-4) to (f-5), and
(l) increasing use of the steps (f-1) to (f-3) when resulting in speeding up said rendering process.

48. The method, as recited in claim 34, further comprising the steps of:
(e) rendering groups of frames using at least two different methods, first groups rendered using visibility evaluation without writing exact depth-values while said compact representation remains sufficient, second groups rendered while said writing exact depth values even if said compact representation is sufficient for visibility evaluation:
(f) interleaving said first and second frame groups during rendering of the same application, while separately monitoring a rendering performance for said first and second groups; and
(g) periodically adjusting ratio of frames in said first and second groups increasing number of frames rendered by one of said methods with best performance.

49. An apparatus for occlusion culling of graphics primitives covering at least a region of a tile, comprising:
a buffer storing a first mask and one or more depth values associated with areas inside and outside said first mask for said region of said tile; and
means for evaluating a visibility of primitives covering said region after computing a coverage mask of said primitives covering said region and computing said one or more depth values representing pixels of each said primitive.

50. The apparatus, as recited in claim 49, further comprising means for determining said first mask from one of said graphics primitives in said region and Z-values as said depth values of said first mask associated with said pixels inside and outside said first mask within said region.

51. The apparatus, as recited in claim 50, wherein said buffer is a Z-mask buffer that stores said first mask and said Z-values thereof.

52. The apparatus, as recited in claim 51, further comprising means for determining a second mask from another graphics primitive in said region and Z-values of said second mask;

53. The apparatus, as recited in claim 52, wherein said visibility of pixels inside said second mask is evaluated by comparing said Z-values of said second mask with said Z-mask buffer, and a third mask for said pixels covered by said first and second masks within said region and a Z-value of said third mask associated with said pixels inside and outside said third mask within said region are determined, wherein said third mask and said Z-values thereof are stored as an updated Z-mask buffer and said Z-value thereof for said region to update said visibility of said pixels so as to enable a bandwidth-saving visibility evaluation for next primitives coving said region.

54. The apparatus, as recited in claim 53, wherein when said evaluation is succeeded in resolving visibility of said pixels, said visible pixels are rendered without reading said Z-mask buffer.

55. The apparatus, as recited in claim 54, wherein when said second mask contains no common pixel with said first mask, said third mask is set to be the union of said first mask and locations of said visible pixel inside said second mask.

56. The apparatus, as recited in claim 55, wherein when said pixel inside said second mask is visible, said third mask is set to be the union of said first mask and locations of said visible pixel inside said second mask.

57. The apparatus, as recited in claim 56, wherein when at least one pixel of said second mask is covered by said first mask and none of said pixels covered by said first and second masks are visible, said third mask is set to be the union of said first mask and locations of said visible pixel inside said second mask.

58. The method, as recited in claim 54, wherein when at least one pixel of said second mask is covered by said first mask and said pixel inside said second mask is visible, said third mask is set to cover locations of said visible pixel of said second mask.

59. The apparatus, as recited in claim 53, wherein a first range of Z-value for said pixels inside said first mask and a second range of Z-value for said pixels outside said first mask are obtained, and a third range of Z-value for said pixels covered by said second mask is also obtained, so that said ranges between said first and second masks are compared while determining said third mask.
